(19) United States
(12) Patent Application Publication
(10) Pub. No.: US 2011/0236624 A1
(43) Pub. Date: Sep. 29, 2011

(54) HONEYCOMB STRUCTURE

(75) Inventors: Sho SAITO, Ibi-gun (JP); Kazuya Naruse, Ibi-gun (JP); Toshiaki Shibata, Ibi-gun (JP)

(73) Assignee: IBIDEN CO., LTD., Ogaki-shi (JP)

(21) Appl. No.: 13/009,157

(22) Filed: Jan. 19, 2011

(30) Foreign Application Priority Data
Mar. 23, 2010 (JP) PCT/JP2010/054959

(51) Int. Cl. B32B 3/12

(52) U.S. Cl. 428/116

(57) ABSTRACT

A honeycomb structure includes a ceramic block including at least one honeycomb fired body. The at least one honeycomb fired body has cell walls to define cells and a peripheral wall constituting a periphery of the at least one honeycomb fired body. The cells include peripheral cells in contact with the peripheral wall of the at least one honeycomb fired body constituting a periphery of the ceramic block and basic cells arranged at an inner side of the peripheral cells. The peripheral cells include deformed cells each having a different shape from the basic cells in a cross section perpendicular to a longitudinal direction of the at least one honeycomb fired body. Each of the deformed cells is capable of receiving therein a circle of about 0.9 mm in diameter in the cross section perpendicular to the longitudinal direction.

### CROSS-REFERENCE TO RELATED APPLICATIONS

The present application claims priority under 35 U.S.C. §119 to International Application No. PCT/JP2010/054959 filed on Mar. 23, 2010, the contents of which are incorporated herein by reference in their entirety.

### BACKGROUND OF THE INVENTION

1. Field of the Invention

The present invention relates to a honeycomb structure.

2. Discussion of the Background

It has been a problem recently that particulates (hereinafter also referred to as PMs) such as soot and other harmful substances contained in the exhaust gases discharged from internal combustion engines of vehicles such as buses or trucks, construction machines, and the like cause damage to environment and human bodies. To overcome such a problem, various honeycomb structures containing porous ceramics have been proposed as honeycomb filters configured to capture PMs in exhaust gases to purify exhaust gases.

Those honeycomb structures, including the honeycomb structure disclosed by JP-A 2004-154718, are conventionally known to have a ceramic block in which a plurality of honeycomb fired bodies each having a large number of cells therein are bonded together. FIGS. 1A and 1B each schematically illustrate an example of a honeycomb fired body (outer honeycomb fired body) located in the outermost periphery of the conventional honeycomb structure described in JP-A 2004-154718, among honeycomb fired bodies used in production of the honeycomb structure. In a honeycomb fired body 1110 and a honeycomb fired body 1120 which are respectively illustrated in FIG. 1A and FIG. 1B, a cell 1111 and a cell 1121 (deformed small cells) closest to the curved surface constituting the peripheral face of the ceramic block each have, in a cross section perpendicular to the longitudinal direction thereof, an almost triangular or almost trapezoidal shape unlike the cells located thereunder (hereinafter, such a shape in a cross section is also referred simply to as a cross-sectional shape). Here, one side of each of the cell 1111 and the cell 1121 is formed along the above curved surface.

JP-A 2004-154718 also discloses a honeycomb structure in which cells are not formed near a fired-body peripheral wall constituting the periphery of the ceramic block among fired-body peripheral walls of honeycomb fired bodies such that filling with a plug material paste is facilitated. FIG. 2A and FIG. 2B each illustrate an example of a honeycomb fired body constituting a conventional honeycomb structure in which cells are not formed near a fired-body peripheral wall constituting the periphery of the ceramic block (hereinafter also referred to as a block peripheral wall). A honeycomb fired body 1130 and a honeycomb fired body 1140 have the same shape as the respective honeycomb fired body 1110 and honeycomb fired body 1120 illustrated in FIG. 1A and FIG. 1B. Here, every cell 1131 in the honeycomb fired body 1130 and every cell 1141 in the honeycomb fired body 1140 have an almost square cross-sectional shape, and no cell is formed near block peripheral walls 1134 and 1144.

Meanwhile, WO 2008/126335 A1 discloses a honeycomb structure in which each cell, in contact with the block peripheral wall constituting the periphery of the ceramic block (hereinafter, such a cell is also referred to as a “cell located in the outermost periphery”) among the fired-body peripheral walls in the honeycomb fired bodies, is designed to have the same cross-sectional shape as the cells located in portions other than the outermost periphery such that filling with a plug material paste is facilitated. FIG. 3A and FIG. 3B each illustrate an example of a honeycomb fired body constituting a conventional honeycomb structure in which cells located in the outermost periphery are designed to have the same cross-sectional shape as the cells located in portions other than the outermost periphery. Every cell 1151 in a honeycomb fired body 1150 and every cell 1161 in a honeycomb fired body 1160 have an almost square cross-sectional shape, and the cells 1151 or the cells 1161 are designed to be located at equal intervals. In order to provide the same cross-sectional shape to the cells located in the outermost periphery and the cells located in portions other than the outermost periphery, a fired-body peripheral wall 1154 of the honeycomb fired body 1150 and a fired-body peripheral wall 1164 of the honeycomb fired body 1160 are designed to have irregularities corresponding to the positions of the cells 1151 and the cells 1161 located in the respective outermost peripheries.

The contents of JP-A 2004-154718 and WO 2008/126335 A1 are incorporated herein by reference in their entirety.

### SUMMARY OF THE INVENTION

According to one aspect of the present invention, a honeycomb structure includes a ceramic block including at least one honeycomb fired body. The at least one honeycomb fired body has a peripheral wall constituting a periphery of the at least one honeycomb fired body and cell walls extending along a longitudinal direction of the at least one honeycomb fired body to define cells. The cells include peripheral cells in contact with the peripheral wall of the at least one honeycomb fired body constituting a periphery of the ceramic block and basic cells arranged at an inner side of the peripheral cells. The peripheral cells include deformed cells each having a different shape from the basic cells in a cross section perpendicular to the longitudinal direction of the at least one honeycomb fired body. Each of the deformed cells is capable of receiving therein a circle of about 0.9 mm in diameter in the cross section perpendicular to the longitudinal direction.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a perspective view schematically illustrating one example of a honeycomb fired body constituting a conventional honeycomb structure;

FIG. 1B is a perspective view schematically illustrating another example of a honeycomb fired body constituting the conventional honeycomb structure;

FIG. 2A is a perspective view schematically illustrating one example of a honeycomb fired body constituting a conventional honeycomb structure;

FIG. 2B is a perspective view schematically illustrating another example of a honeycomb fired body constituting the conventional honeycomb structure;

FIG. 3A is a perspective view schematically illustrating one example of a honeycomb fired body constituting a conventional honeycomb structure;

FIG. 3B is a perspective view schematically illustrating another example of a honeycomb fired body constituting the conventional honeycomb structure;

FIG. 4 is a perspective view schematically illustrating a honeycomb structure according to a first embodiment of the present invention;

FIG. 5A is a perspective view schematically illustrating an inner honeycomb fired body of the honeycomb structure according to the first embodiment of the present invention;

FIG. 5B is a B-B line cross-sectional view of the inner honeycomb fired body illustrated in FIG. 5A;

FIG. 6A is a perspective view schematically illustrating an example of an outer honeycomb fired body of the honeycomb structure according to the first embodiment of the present invention;

FIG. 6B is a cross-sectional view schematically illustrating a portion near an end of the outer honeycomb fired body illustrated in FIG. 6A;

FIG. 7 is an A-A line cross-sectional view of the honeycomb structure illustrated in FIG. 4;

FIG. 8 is a cross-sectional view of a honeycomb structure according to a second embodiment of the present invention;

FIG. 9A is a cross-sectional view schematically illustrating a portion near an end of an outer honeycomb fired body constituting the honeycomb structure according to the second embodiment of the present invention;

FIG. 9B is a cross-sectional view schematically illustrating a portion near an end of another outer honeycomb fired body constituting the honeycomb structure according to the second embodiment of the present invention;

FIG. 10A is a cross-sectional view schematically illustrating a portion near an end of an outer honeycomb fired body constituting a honeycomb structure according to a third embodiment of the present invention;

FIG. 10B is a cross-sectional view schematically illustrating a portion near an end of an inner honeycomb fired body constituting the honeycomb structure according to the third embodiment of the present invention;

FIG. 11A is a cross-sectional view schematically illustrating a honeycomb structure according to a fourth embodiment of the present invention;

FIG. 11B is a cross-sectional view schematically illustrating a portion near an end of an outer honeycomb fired body constituting the honeycomb structure illustrated in FIG. 11A;

FIG. 11C is a cross-sectional view schematically illustrating a portion near an end of another outer honeycomb fired body constituting the honeycomb structure illustrated in FIG. 11A;

FIG. 12 is a cross-sectional view of a honeycomb structure according to another embodiment of the present invention; and

FIG. 13 is a graph showing the diameters of the insertable circles and the sealing-defect rates in Examples 1 to 4 and Comparative Examples 1 to 4.

### DESCRIPTION OF THE EMBODIMENTS

The embodiments will now be described with reference to the accompanying drawings, wherein like reference numerals designate corresponding or identical elements throughout the various drawings.

In a sealing process of the cells 1111 of the honeycomb fired body 1110 and the cells 1121 of the honeycomb fired body 1120 which constitute the conventional honeycomb structure described in JP-A 2004-154718, filling with a plug material paste may be difficult and the plug material paste may be easily leaked and/or overflowing, and this may easily lead to insufficient sealing of the cells.

If a honeycomb structure having such a honeycomb fired body with the insufficiently sealed cells is used as an exhaust gas purifying filter, exhaust gases having flowed into the honeycomb structure may flow out of the same cell without passing through the cell wall, which means that the honeycomb structure does not function as a filter.

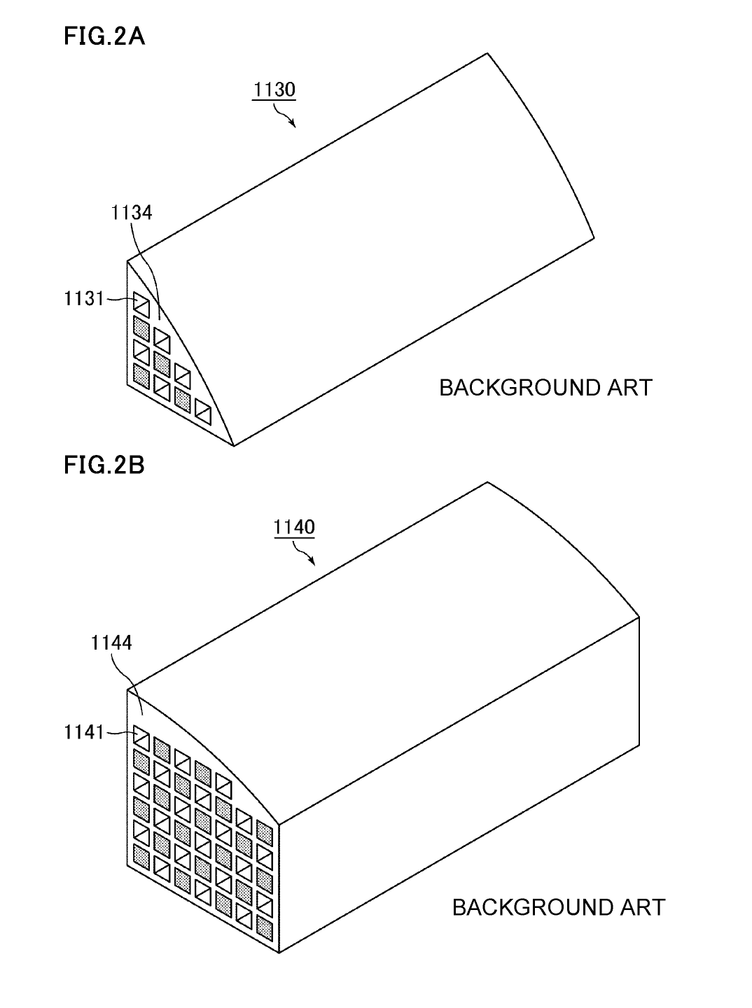

A conventional honeycomb structure formed from honeycomb fired bodies illustrated in FIGS. 2A and 2B do not have cells having small aperture areas which, in a conventional honeycomb structure, cause a difficulty in filling with a plug material paste. This structure apparently facilitates filling with a plug material paste, thereby improving the manufacturing efficiency of honeycomb structures.

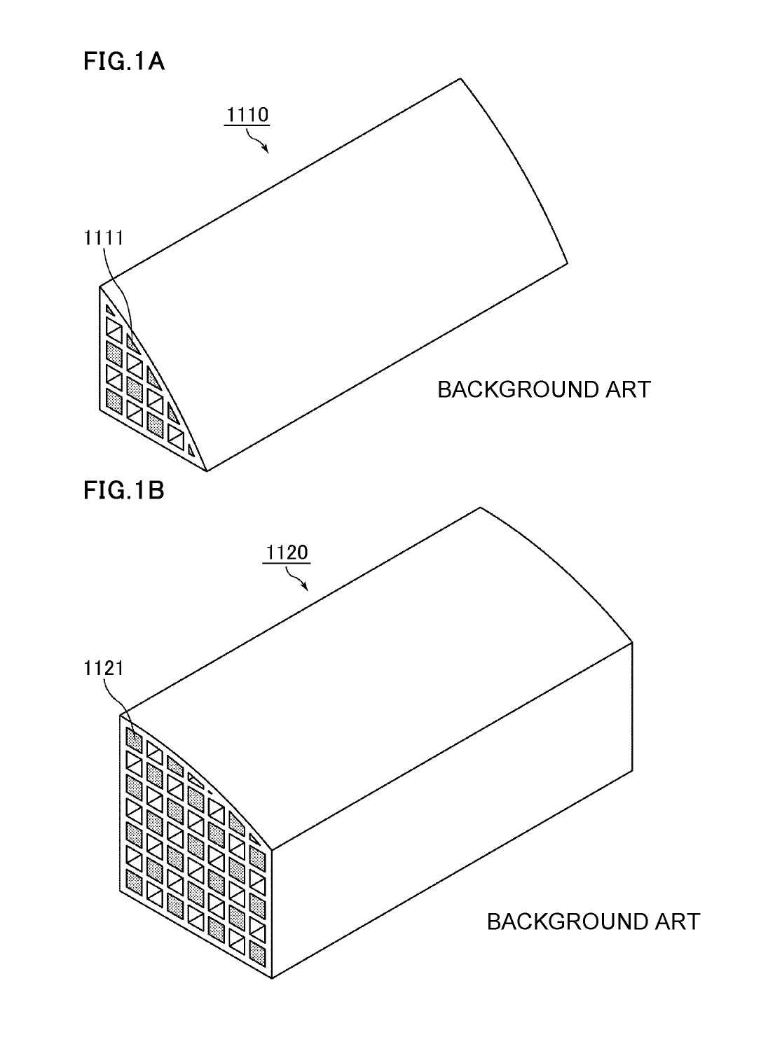

Such a conventional honeycomb structure, however, has a problem that the aperture ratio (opening ratio) of the whole honeycomb structure tends to be low and therefore sufficiently capturing PMs is more difficult for the honeycomb structure than for the conventional honeycomb structure having illustrated in FIG. 1A and FIG. 1B.

The conventional honeycomb structure formed from the honeycomb fired bodies illustrated in FIGS. 2A and 2B has the same aperture area for the outermost periphery cells, which have small aperture areas in a conventional honeycomb structure and bring difficulty in filling with a plug material paste, and for the cells other than the outermost periphery cells. This structure facilitates filling with a plug material paste and makes it easier to improve a manufacturing efficiency of honeycomb structures. However, such a conventional honeycomb structure has a problem that the aperture ratio of the honeycomb structure tends to be low and therefore sufficiently capturing PMs is more difficult for the honeycomb structure than for the conventional honeycomb structure illustrated in FIG. 1A and FIG. 1B.

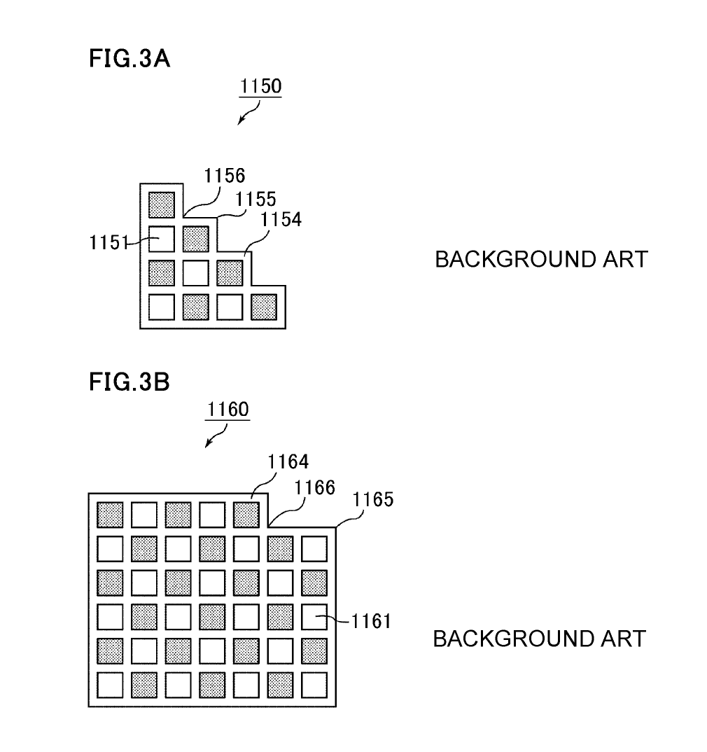

Each honeycomb fired body constituting the conventional honeycomb structure according to WO 2008/126335 A1 has an irregularity on the peripheral wall thereof. More specifically, the honeycomb fired body has an irregularity due to a projected portion 1155 and a recessed portion 1156 or an irregularity due to a projected portion 1165 and a recessed portion 1166, as illustrated in FIG. 3A and FIG. 3B.

A honeycomb fired body having such a structure is also formed by extrusion-molding a wet mixture into a honeycomb molded body. The honeycomb molded body may easily have molding defects that a projected portion on the peripheral wall of the honeycomb molded body chips when coming into contact with a jig or the like, or a depressed portion has cracks occurred therein due to expansion and contraction of the honeycomb molded body and the honeycomb fired body, in processes such as a drying process, a firing process, and an assembling process of a honeycomb structure after the extrusion-molding. The molding defects may easily decrease the manufacturing efficiency of honeycomb structures.

Also, if a honeycomb structure is manufactured using such a honeycomb fired body, the manufactured honeycomb structure still has projected portions and recessed portions on the periphery thereof. For this reason, the honeycomb structure, when used as a honeycomb filter and exposed to high temperatures, may easily have defects such as chipped portions and/or cracks on the periphery thereof because of expansion and contraction of the honeycomb fired bodies.

The embodiment of the present invention may easily provide a honeycomb structure that facilitates filling with a plug material paste for sealing cells, and that is less likely to cause defects such as chipping, and has a high aperture ratio.

The honeycomb structure according to the embodiment of the present invention includes a ceramic block, the ceramic block including a honeycomb fired body that has a peripheral wall constituting a periphery of the honeycomb fired body and has a plurality of cells longitudinally disposed in parallel with one another with a cell wall interposed between the cells, wherein the cells include: peripheral cells in contact with a peripheral wall of the honeycomb fired body constituting a periphery of the ceramic block; and basic cells residing under the peripheral cells, the peripheral cells include deformed cells each having a different shape from the basic cells in a cross section perpendicular to the longitudinal direction of the honeycomb fired body, and each of the deformed cells is capable of receiving therein a circle of about 0.90 mm in diameter, in a cross section perpendicular to the longitudinal direction.

In the honeycomb structure according to the embodiment of the present invention, the peripheral cells include deformed cells each having a different shape from the basic cells in a cross section perpendicular to the longitudinal direction, and each of the deformed cells is capable of receiving therein a circle of about 0.90 mm in diameter, in a cross section perpendicular to the longitudinal direction.

Conventionally, peripheral cells in outer honeycomb fired bodies (conventional honeycomb fired bodies) include a deformed small cell incapable of receiving therein a circle of about 0.90 mm in diameter and thereby having a small aperture area. This structure may make it difficult to fill the deformed small cell with a plug paste material or easily cause leakage or overflow of the plug material, thereby easily causing a problem of insufficient sealing of cells.

However, in the honeycomb structure according to the embodiment of the present invention, every deformed cell is capable of receiving therein a circle of about 0.90 mm in diameter and thereby has a comparatively large aperture area, and all the other cells are basic cells. The honeycomb structure therefore facilitates filling with a plug material paste and is less likely to cause leakage or overflow of the plug material, thereby more easily enabling excellent sealing of the deformed cells. Accordingly, defective cells not performing the functions of a honeycomb filter, such as capturing of PMs, are less likely to be formed, and the honeycomb structure of the embodiment of the present invention tends to excellently perform the functions required for a honeycomb structure used as a honeycomb filter, such as capturing of PMs.

Further, in the honeycomb structure according to the embodiment of the present invention, not every deformed cell is filled, and deformed cells capable of receiving therein a circle of about 0.90 mm in diameter in a cross section perpendicular to the longitudinal direction function as a part of the filter. Hence, the aperture ratio of the whole honeycomb structure can be easily maintained high and PMs tend to be sufficiently captured.

Also, since the honeycomb structure according to the embodiment of the present invention has the deformed cells on the periphery of the ceramic block (honeycomb fired body), a projected portion on the periphery of the ceramic block (honeycomb fired body) tends to have a gentle slope compared to the case where all the peripheral cells are basic cells. With this structure, stress concentration is less likely to occur when the honeycomb structure is exposed to high temperatures, and thus chipping of the projected portion is less likely to occur.

Each of the above deformation cells is preferably incapable of receiving therein a circle of about 1.57 mm in diameter in a cross section perpendicular to the longitudinal direction. A deformed cell capable of receiving therein a circle of about 1.57 mm has a very large cell cross section, which may easily lead to insufficient mechanical strength.

A cell wall of a honeycomb fired body herein refers to a portion that exists between two cells and separates the two cells. A peripheral wall of a honeycomb fired body herein refers to a wall portion that constitutes the periphery of the honeycomb fired body.

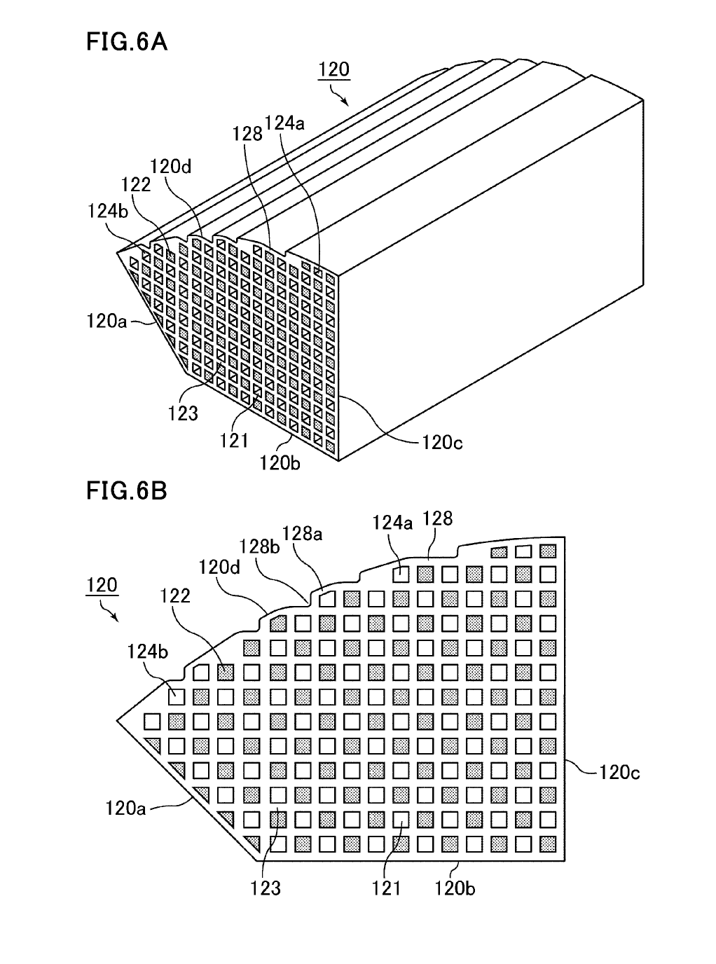

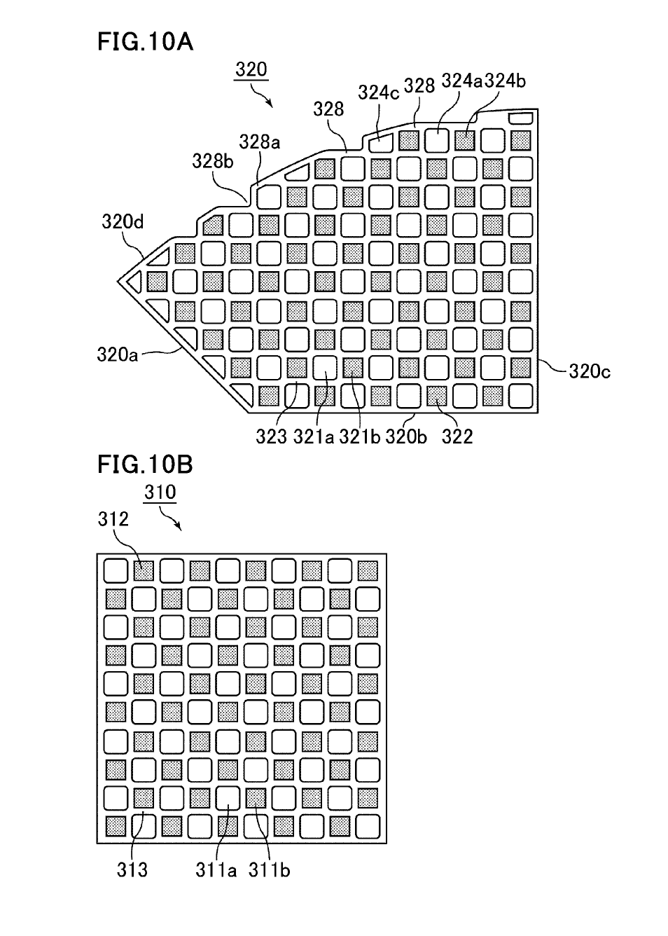

Basic cells herein refer to the smallest unit of cells having substantially the same shape or different shapes which are repeatedly formed vertically and horizontally when the cells constituting a honeycomb fired body are observed in a cross section perpendicular to the longitudinal direction. For example, an outer honeycomb fired body 120 illustrated in FIG. 6A and FIG. 6B has almost square cells repeatedly arranged in a cross section perpendicular to the longitudinal direction of the outer honeycomb fired body. In this case, the approximate square cells are the basic cells. Also, in an inner honeycomb fired body 310 illustrated in FIG. 10B, for example, two kinds of cells having different cell cross-sectional areas are repeatedly arranged. In this case, the cells having different cell cross-sectional areas in combination are the basic cells. Note that only one of the cells having different cell cross-sectional areas may be referred to as a basic cell for convenience. A basic formation pattern herein refers to the shape of the basic cell.

A deformed cell herein refers to a kind of a peripheral cell that is in contact with the peripheral wall of an outer honeycomb fired body, and has a shape lacking a part of the shape of a basic cell and a smaller cell cross-sectional area than the basic cell, when observed in a cross section perpendicular to the longitudinal direction of cells constituting the outer honeycomb fired body. In the case that the basic cells correspond to the cells having the same shape, a cell having a smaller cross-sectional area than the basic cells is referred to as a deformed cell. In the case that the basic cells correspond to the cells having different cell cross-sectional areas arranged in a pattern in which those cells in combination are repeatedly arranged in an outer honeycomb fired body, for example, a cell having a smaller cell cross-sectional area than the cell having a comparatively large cell cross-sectional area in the above pattern, or a cell having a smaller cell cross-sectional area than the cell having a comparatively small cell cross-sectional area in the above pattern is referred to as a deformed cell. A deformed cell is also referred to as an incomplete cell.

In the honeycomb structure according to the embodiment of the present invention, each of the deformed cells is preferably capable of receiving therein a circle of about 0.95 mm in diameter, in a cross section perpendicular to the longitudinal direction.

In the honeycomb structure according to the embodiment of the present invention, a deformed cell is capable of receiving therein a circle of about 0.95 mm in diameter in a cross-sectional perpendicular to the longitudinal direction and has a larger aperture area. A deformed cell therefore tends to be sealed better and perform in a better way the functions such as capturing of PMs which are required for a honeycomb structure used as a honeycomb filter.

In the honeycomb structure according to the embodiment of the present invention, the aperture ratio of the whole honeycomb structure tends to be maintained higher, which more easily enables sufficient capturing of PMs.

In the honeycomb structure according to the embodiment of the present invention, a projected portion on the periphery of the ceramic block (honeycomb fired body) tends to have a gentle slope. With this structure, stress concentration is less likely to occur when the honeycomb structure is exposed to high temperatures, and thus chipping of the projected portion is less likely to occur.

In the honeycomb structure according to the embodiment of the present invention, it is preferable that the cells further include a deformed small cell incapable of receiving therein a circle of about 0.90 mm in diameter, and the peripheral wall constituting the periphery of the ceramic block include a peripheral wall formed by completely filling the deformed small cell with the same material as the material of the cell walls.

Since the deformed small cell is completely filled in manufacture of a honeycomb molded body in the honeycomb structure according to the embodiment of the present invention, filling with a plug material paste is not required, and thus filling defects in the deformed small cell are more easily prevented.

In the honeycomb structure according to the embodiment of the present invention, the ceramic block is preferably formed by bonding a plurality of honeycomb fired bodies by interposing adhesive layers.

Even in the case that a ceramic block is formed by bonding a plurality of honeycomb fired bodies by interposing adhesive layers as described above, the honeycomb structure has deformed cells each being capable of receiving therein a circle of about 0.90 mm in diameter in a cross section perpendicular to the longitudinal direction, and thereby achieves the same effects as in the above cases.

The honeycomb structure according to the embodiment of the present invention achieves the same effects as in the above cases because the ceramic block is formed by combining the honeycomb fired bodies having different shapes from each other, and preferably includes outer honeycomb fired bodies each having a peripheral wall constituting the periphery of the ceramic block; and inner honeycomb fired bodies located under the outer honeycomb fired bodies.

In the honeycomb structure according to the embodiment of the present invention, it is preferable that the peripheral wall of the honeycomb fired body constituting the periphery of the ceramic block have an irregularity including a projected portion and a recessed portion, in a cross section perpendicular to the longitudinal direction, the projected portion have a shape defined by a curved line formed by chamfering the projected portion, and the recessed portion have a shape defined by a curved line formed by chamfering the recessed portion.

In the honeycomb structure according to the embodiment of the present invention, stress concentration is less likely to occur when the honeycomb structure is exposed to high temperatures and stress generated is more likely to be relieved, whereby it may be easier to effectively prevent chipping and/or cracks in the projected portion and/or the recessed portion.

Chamfering of a projected portion of a peripheral wall of an outer honeycomb fired body herein refers to the state where the projected portion has a shape formed by cutting the corners of the peripheral wall. Meanwhile, chamfering of a recessed portion of a peripheral wall of an outer honeycomb fired body herein refers to the state where the recessed portion has a shape formed by filling corners of the peripheral wall such that recessed portion has the same shape as the shape formed by supposedly chamfering the corners of the peripheral wall. For example, if a recessed portion has the same shape as the shape formed by supposedly chamfering (C-chamfering) or round-chamfering (R-chamfering) the peripheral wall of an outer honeycomb fired body, the recessed portion is C-chamfered or R-chamfered.

In the honeycomb structure according to the embodiment of the present invention, it is preferable that the projected portion have a shape formed by R-chamfering the projected portion, the recessed portion have a shape formed by R-chamfering the recessed portion, and a curvature radius for the R-chamfering be from about 0.3 mm to about 2.5 mm.

In the honeycomb structure according to the embodiment of the present invention, stress concentration is less likely to occur when the honeycomb structure is exposed to high temperatures and stress generated tends to be more effectively relieved, whereby defects such as cracks tend to be more effectively prevented. A curvature radius for the R-chamfering of about 0.3 mm or more may make it easier to more effectively relieve the stress generated by heat or the like. In contrast, a curvature radius for the R-chamfering of about 2.5 mm or less may not make the processing of the R-chamfering so difficult.

In the honeycomb structure according to the embodiment of the present invention, each of the basic cells and each of the peripheral cells excluding the deformed cells preferably have an almost quadrangular shape in a cross section perpendicular to the longitudinal direction.

In the honeycomb structure according to the embodiment of the present invention, it is preferable that the basic cells and the peripheral cells excluding the deformed cells include large-volume cells and small-volume cells, and each of the large-volume cells have a larger area than the small-volume cells in a cross section perpendicular to the longitudinal direction.

When the honeycomb structure according to the embodiment of the present invention is used as a filter for purifying exhaust gases, a large amount of PMs may be easily captured.

In the honeycomb structure according to the embodiment of the present invention, each of the large-volume cells and each of the small-volume cells preferably have an almost quadrangular shape, in a cross section perpendicular to the longitudinal direction.

In the honeycomb structure according to the embodiment of the present invention, it is preferable that each of the large-volume cells have an almost octagonal shape and each of the small-volume cells have an almost quadrangular shape, in a cross section perpendicular to the longitudinal direction.

Since each large-volume cell has an almost octagonal cross-sectional shape and each small-volume cell has an almost quadrangular cross-sectional shape in the honeycomb structure according to the embodiment of the present invention, large-volume cells and small-volume cells are easily arranged with good symmetry. Such structure is less likely to cause distortion or the like to the cell walls, and therefore may easily manufacture a honeycomb structure with excellent mechanical strength.

In the honeycomb structure according to the embodiment of the present invention, each of the large-volume cells and each of the small-volume cells preferably have a shape defined by a curved line, in a cross section perpendicular to the longitudinal direction.

Accordingly, stress concentration is less likely to occur in the cell walls, and thus cracks and the like are less likely to occur in the cell walls.

In the honeycomb structure according to the embodiment of the present invention, the peripheral wall of the honeycomb fired body constituting the periphery of the ceramic block preferably has a larger thickness than a cell wall located on an inner side of the honeycomb fired body.

In the honeycomb structure according to the embodiment of the present invention, the peripheral wall of the honeycomb fired body constituting the periphery of the ceramic block preferably has a thickness of from about 1.3 times to about 3.0 times the thickness of a cell wall located on an inner side of the honeycomb fired body.

In each honeycomb fired body in the honeycomb structures according to the embodiments of the present invention, each peripheral wall has a larger thickness than the inner cell walls. Accordingly, the peripheral wall of each honeycomb fired body is less likely to be broken when a compression force or the like generates outside, and thus a honeycomb structure with excellent mechanical strength may be easily provided. A thickness of a peripheral wall of the honeycomb fired body constituting the periphery of about 1.3 times or more of the thickness of a cell wall located on an inner side of the honeycomb fired body may easily improve the mechanical strength of the peripheral wall. In contrast, a thickness of a peripheral wall of the honeycomb fired body constituting the periphery of about 3.0 times or less of the thickness of a cell wall located on an inner side of the honeycomb fired body may not be very large and thus may not easily decrease the aperture ratio of the honeycomb structure.

In the honeycomb structure according to the embodiment of the present invention, it is preferable that each of the outer honeycomb fired bodies in a cross section be an approximate sector having a shape defined by three straight lines and a peripheral wall constituting a part of the periphery of the ceramic block in a cross section perpendicular to the longitudinal direction, and each of the inner honeycomb fired bodies have an almost quadrangular shape in a cross section perpendicular to the longitudinal direction.

In the honeycomb structure according to the embodiment of the present invention, honeycomb fired bodies each having an almost sector cross-sectional shape and honeycomb fired bodies each having an almost quadrangular cross-sectional shape are combined. With such a structure, a honeycomb structure may easily be formed from a small number of honeycomb fired bodies in a more efficient manner. Accordingly, honeycomb structures are manufactured easily, and thereby the manufacturing cost is decreased.

In the honeycomb structure according to the embodiment of the present invention, the cells are preferably sealed at alternate ends. The above honeycomb structure therefore functions as a filter.

In the honeycomb structure according to the embodiment of the present invention, the ceramic block preferably has a coat layer formed on the periphery thereof.

The honeycomb structure according to the embodiments of the present invention includes a ceramic block, the ceramic block including a honeycomb fired body that has a peripheral wall formed around a periphery of the honeycomb fired body and has a plurality of cells longitudinally disposed in parallel with one another with a cell wall interposed between the cells, wherein the cells include peripheral cells in contact with the peripheral wall constituting a periphery of the ceramic block; and basic cells residing under the peripheral cells, the peripheral cells include deformed cells each having a different shape from the basic cells in a cross section perpendicular to the longitudinal direction of the honeycomb fired body, and each of the deformed cells is capable of receiving therein a circle of about 0.90 mm in diameter, in a cross section perpendicular to the longitudinal direction.

The ceramic block is preferably formed by bonding a plurality of honeycomb fired bodies by interposing adhesive layers. Further, the ceramic block is preferably formed by combining the honeycomb fired bodies having different shapes from each other, and preferably includes outer honeycomb fired bodies each having a peripheral wall constituting the periphery of the ceramic block; and inner honeycomb fired bodies residing under the outer honeycomb fired bodies.

Hereinafter, specific embodiments of the honeycomb structure according to the embodiments of the present invention will be described.

### First Embodiment

A first embodiment of the honeycomb structure of the present invention will be described with reference to the drawings.

Across section of a honeycomb structure, a cross section of a honeycomb fired body, and a cross section of a honeycomb molded body herein respectively refer to a cross section perpendicular to the longitudinal direction of the honeycomb structure, a cross section perpendicular to the longitudinal direction of the honeycomb fired body, and a cross section perpendicular to the longitudinal direction of the honeycomb molded body. A cross-sectional area of a honeycomb fired body herein refers to a cross-sectional area of a cross section perpendicular to the longitudinal direction of the honeycomb fired body.

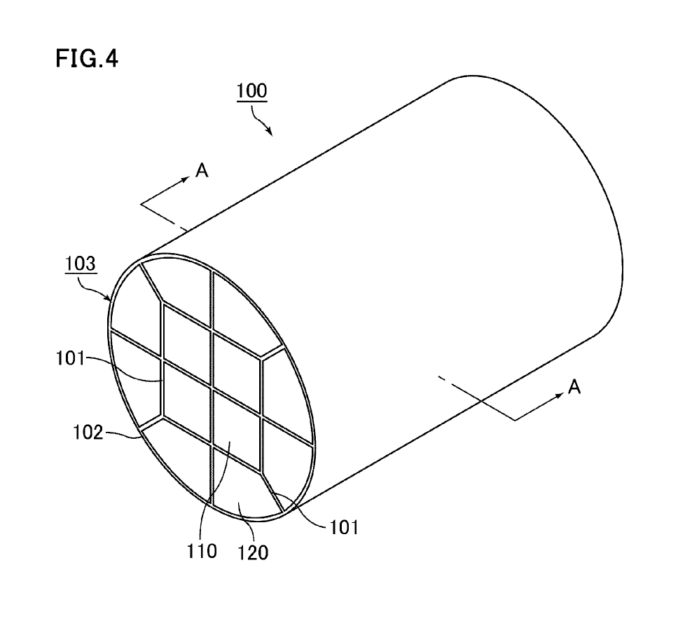

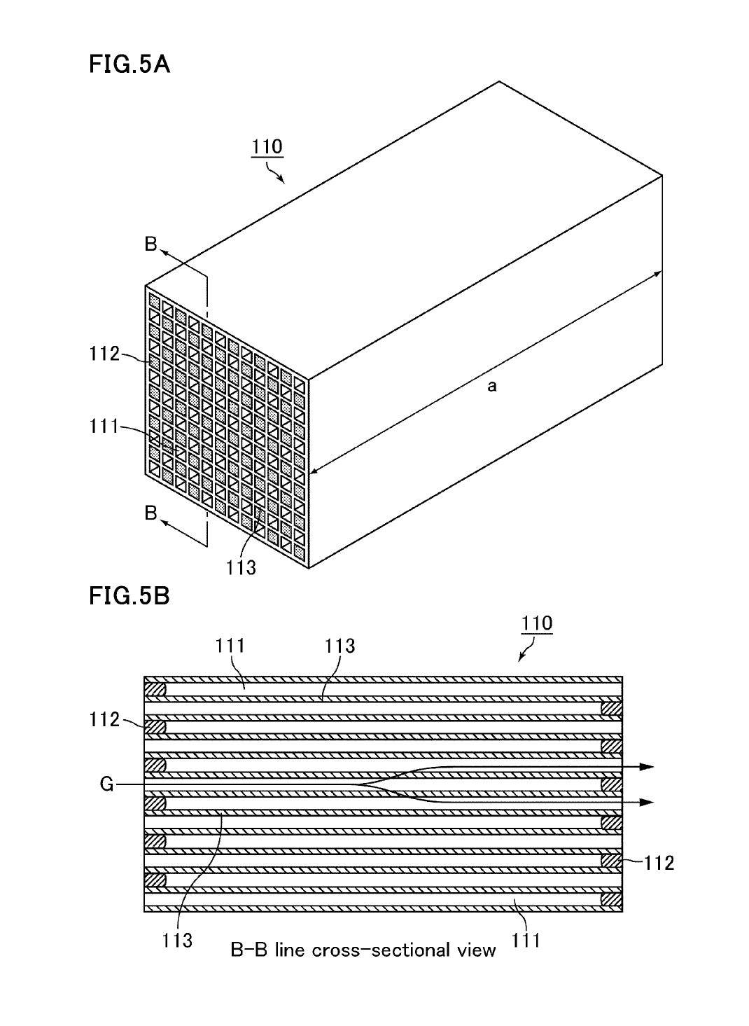

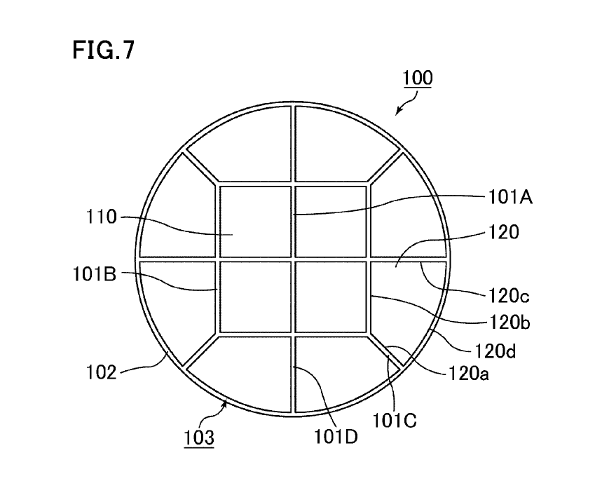

FIG. 4 is a perspective view schematically illustrating a honeycomb structure according to the first embodiment of the present invention. FIG. 5A is a perspective view schematically illustrating an inner honeycomb fired body constituting the honeycomb structure according to the first embodiment of the present invention. FIG. 5B is a B-B line cross-sectional view of the inner honeycomb fired body illustrated in FIG. 5A. FIG. 6A is a perspective view schematically illustrating an outer honeycomb fired body constituting the honeycomb structure according to the first embodiment of the present invention. FIG. 6B is a cross-sectional view schematically illustrating a portion near an end of the outer honeycomb fired body illustrated in FIG. 6A. FIG. 7 is an A-A line cross-sectional view of the honeycomb structure illustrated in FIG. 4.

A honeycomb structure 100 illustrated in FIG. 4 and FIG. 7 has a ceramic block 103 formed by bonding, by interposing adhesive layers 101 (101A to 101D), eight outer honeycomb fired bodies 120 each having a shape illustrated in FIGS. 6A and 6B and four inner honeycomb fired bodies 110 each having a shape illustrated in FIGS. 5A and 5B located under the outer honeycomb fired bodies. The ceramic block 103 has a coat layer 102 formed around the periphery thereof.

Each inner honeycomb fired body 110 has an almost square cross-sectional shape.

Each outer honeycomb fired body 120 in a cross section is an approximate sector having a shape defined by three lines 120a, 120b, and 120c and one approximate circular arc 120d as illustrated in FIG. 7. Here, two angles each formed by two lines out of the three lines (the angle formed by the line 120b and the line 120c, and the angle formed by the line 120a and the line 120b) are about 90° and about 135°, respectively. The shape of the approximate circular arc will be described later.

In a peripheral portion in a cross section of the honeycomb structure 100, an adhesive layer 101C provided from a corner of the central portion toward the periphery of the honeycomb structure 100 and an adhesive layer 101D provided from a portion of the central portion, other than the corner, toward the periphery of the honeycomb structure 100 form an angle of about 45°.

An inner honeycomb fired body 110 illustrated in FIGS. 5A and 5B has a large number of cells 111 longitudinally (in the direction of an arrow “a” in FIG. 5A) disposed in parallel with one another with cell walls 113 interposed therebetween, and the cells 111 are sealed with plugs 112 at alternate ends. Hence, exhaust gases G (see the arrow in FIG. 5B) having flowed into a cell 111 with one end open surely pass through the cell walls 113 separating the cells 111 before flowing out of other cells 111 with the other ends open. The cell walls 113 therefore function as filters for capturing PMs.

Similarly to the inner honeycomb fired body 110, an outer honeycomb fired body 120 illustrated in FIGS. 6A and 6B has a large number of cells 121 longitudinally disposed in parallel with one another with cell walls 123 interposed therebetween, and the cells 121 are sealed with plugs 122 at alternate ends. Hence, exhaust gases having flowed into a cell 121 with one end open surely pass through the cell walls 123 separating the cells 121 before flowing out of other cells 121 with the other ends open.

That is, although the outer honeycomb fired body 120 differs in the appearance from the inner honeycomb fired body 110, the function of the outer honeycomb fired body 120 is substantially the same as that of the inner honeycomb fired body 110.

As illustrated in FIGS. 6A and 6B, the outer honeycomb fired body 120 has a peripheral wall 128 constituting the periphery of the ceramic block 103. The cells 121 and 124 (124a, 124b) of the outer honeycomb fired body 120 include peripheral cells 124a and 124b in contact with the peripheral wall 128 constituting the periphery of the ceramic block 103, and basic cells 121 located under the peripheral cells 124a and 124b. The peripheral cells 124a and 124b of the outer honeycomb fired body 120 include the basic cells 124b each having the same shape as the basic cells 121 and the deformed cells 124a each having a different shape from the basic cells 124b in a cross section perpendicular to the longitudinal direction. Each deformed cell 124a is capable of receiving therein a circle of about 0.90 mm in diameter in a cross section perpendicular to the longitudinal direction. Such a cell incapable of receiving therein a circle of about 0.90 mm in diameter is completely filled with the same material as the material of the cell walls so as to be a part of the peripheral wall 128 of the honeycomb fired body, or is removed to leave a recessed portion in a cross section.

A cell having a smaller size than the almost quadrangular (approximate square) shape of the inner cells (basic cells) in a cross section perpendicular to the longitudinal direction is referred to as a deformed cell. Here, the cross section of the cell may have a shape with right-angle corners, or may have a shape that the portion corresponding to a corner is a circular arc (a shape formed by supposedly R-chamfering a cell) or chamfered (a shape formed by supposedly C-chamfering a cell).

A cell incapable of receiving therein a circle of about 0.90 mm in diameter may be filled with the same material as the material of the cell walls so as to be a part of the peripheral wall of the honeycomb fired body, or may be removed to leave a recessed portion in a cross section of a ceramic block perpendicular to the longitudinal direction of the cells. Alternatively, the above two structures may be employed together. A recessed portion in a cross section of a ceramic block perpendicular to the longitudinal direction of a cell may be simply referred to as a cross-sectional recessed portion.

A cell capable of receiving therein a circle of about 0.90 mm in diameter may be determined by inserting a jig (for example, a metal stick, a ceramic stick) of about 0.90 mm in diameter into an actual cell to see whether the jig is insertable into the cell or breaks (cracks, cleaves, or the like) the cell at the time of insertion, or by comparing the dimension of the cell in the design drawing and the dimension of an insertable circle. Determination is preferably made from a design drawing in terms of ease of determination and ease of the actual work.

If there is a deformed small cell having a small aperture area and incapable of receiving therein a circle of about 0.90 mm in diameter, filling with a plug material paste may be difficult or leakage and overflow of the plug material may easily occur, which may easily lead to insufficient sealing of the cells.

However, in the honeycomb structure 100 of the present embodiment, every deformed cell 124a has a comparatively large aperture area and is capable of receiving therein a circle of about 0.90 mm in diameter, and the other cells are the basic cells 121 and 124b. Accordingly, filling with a plug material paste is easy, leakage and overflow of the plug material are less likely to occur, and therefore the deformed cells may be more easily well sealed.

Further, in the above, the peripheral wall 128 is described to have an almost circular arc shape in a cross section perpendicular to the longitudinal direction. This means that the peripheral wall has an irregularity due to a projected portion 128a and a recessed portion 128b in a cross section perpendicular to the longitudinal direction of the honeycomb fired body, and the projected portion 128a and the recessed portion 128b each have a cross-sectional shape defined by a curved line formed by R-chamfering. The curvature radius for the R-chamfering is preferably from about 0.3 mm to about 2.5 mm.

The honeycomb fired bodies 110 and 120 constituting the honeycomb structure 100 are preferably porous bodies formed by silicon carbide or silicon-containing silicon carbide.

Next, the method of manufacturing the honeycomb structure according to the present embodiment is described. Here, a case is described in which silicon carbide powder is used as ceramic powder.

(1) A formation process of manufacturing a honeycomb molded body is performed by extrusion-molding a wet mixture that contains ceramic powder and a binder. Specifically, silicon carbide powders (as a ceramic powder) having different average particle sizes from each other, an organic binder, a liquid plasticizer, a lubricant, and water are mixed in a wet-mixing apparatus to prepare a wet mixture for manufacturing a honeycomb molded body.

Then, the above wet mixture is fed into an extrusion-molding apparatus. By feeding the wet mixture into the extrusion-molding apparatus to extrusion-mold the mixture in this way, a honeycomb molded body is manufactured which has a predetermined shape.

Here, in order to manufacture a honeycomb molded body having an almost square cross section or a honeycomb molded body having a cross-sectional shape defined by three lines and one circular arc with two angles of about 90° and about 135° each formed by two lines out of the three lines, extrusion-molding dies corresponding to the respective shapes are used.

(2) Next, the honeycomb molded body is cut to have a predetermined length, and dried by using a drying apparatus such as a microwave drying apparatus, a hot-air drying apparatus, a dielectric drying apparatus, a reduced-pressure drying apparatus, a vacuum drying apparatus, and a freeze drying apparatus. Thereafter, a sealing process is carried out in which predetermined cells each are filled with a plug material paste that is to be a plug. At this time, since a deformed cell is capable of receiving therein a circle of about 0.90 mm in diameter, sealing operations tend to be performed well.

Here, those conditions conventionally used for manufacturing honeycomb fired bodies can be adopted as the conditions of the cutting process, the drying process, and the sealing process.

(3) The honeycomb molded bodies are then processed by a degreasing process which is for heating the organic substances of the honeycomb molded body in a degreasing furnace.

Then, the honeycomb molded body is transported to a firing furnace so as to be processed by a firing process, whereby a honeycomb fired body is manufactured.

Here, those conditions conventionally used for manufacturing honeycomb fired bodies can be adopted as the conditions of the degreasing process and the firing process.

Those processes enable manufacture of an inner honeycomb fired body and an outer honeycomb fired body.

(4) Subsequently, an adhesive paste is applied to predetermined sides of the inner honeycomb fired body and outer honeycomb fired body each having the predetermined end of each cell sealed therein such that an adhesive paste layer is formed. After that, another honeycomb fired body is successively stacked onto the adhesive layer. Repeating this process leads to manufacture of a ceramic block in which a predetermined number of honeycomb fired bodies are combined.

The adhesive paste used here contains, for example, an inorganic binder, an organic binder, and inorganic particles. Moreover, the adhesive paste may further contain at least one of inorganic fibers and whiskers.

(5) A coat layer forming process is further carried out in which a coating material paste is applied to the periphery of the almost round-pillar shaped ceramic block, and is dried and solidified into a coat layer.

The coating material paste used here is the same paste as the adhesive paste. Alternatively, a coating material paste having a different composition from the adhesive paste may be used.

Here, a coat layer is not necessarily provided, and may be provided according to need.

The above processes enable manufacture of a honeycomb structure according to the present embodiment.

Hereinafter, the effects of a honeycomb structure according to the present embodiment will be listed.

(1) In the honeycomb structure of the present embodiment, the peripheral cells of the outer honeycomb fired body include deformed cells each having a different shape from the basic cells in a cross section perpendicular to the longitudinal direction, and each of the deformed cells is capable of receiving therein a circle of about 0.90 mm in diameter, in a cross section perpendicular to the longitudinal direction.

The honeycomb structure therefore facilitates filling with a plug material paste and is less likely to cause leakage or overflow of the plug material, thereby more easily enabling excellent sealing of the deformed cells.

Further, in the honeycomb structure according to the present embodiment, the deformed cells are neither entirely removed nor filled with the same material as the material of the cell walls. That is, the deformed cells function as a part of the filter. Hence, the aperture ratio of the whole honeycomb structure can be easily maintained high and PMs tend to be sufficiently captured.

Since the honeycomb structure according to the present embodiment has the deformed cells on the periphery of the ceramic block, a projected portion on the periphery of the ceramic block has a gentle slope compared to the case where all the peripheral cells are basic cells. With this structure, chipping of the projected portion is less likely to be caused by stress concentration which occurs when the honeycomb structure is brought into contact with a jig or the like or exposed to high temperatures.

(3) In the honeycomb fired body according to the present embodiment, cells are sealed with plugs at alternate ends. The honeycomb structure according to the present embodiment is therefore more likely to be suitably used as a diesel particulate filter.

(4) In the honeycomb structure according to the present embodiment, the peripheral wall has an irregularity due to a projected portion and a recessed portion in a cross section perpendicular to the longitudinal direction, and the projected portion and the recessed portion each have a cross-sectional shape defined by a curved line formed by respectively R-chamfering the projected portion and the recessed portion. Accordingly, stress concentration is less likely to occur when the honeycomb structure is brought into contact with a jig or the like or exposed to high temperatures, and stress generated by heat or the like may be easily relieved, whereby it may be easier to effectively prevent chipping and/or cracks in the projected portion and/or the recessed portion.

Hereinafter, Examples are shown which more specifically disclose the first embodiment of the present invention. The present invention is not limited to those Examples.

### EXAMPLES

### Example 1

(1) An amount of 52.8% by weight of a silicon carbide coarse powder having an average particle diameter of 22 μm and 22.6% by weight of a silicon carbide fine powder having an average particle diameter of 0.5 μm were mixed. To the resulting mixture, 2.1% by weight of an acrylic resin, 4.6% by weight of an organic binder (methylcellulose), 2.8% by weight of a lubricant (UNILUB, manufactured by NOF Corporation), 1.3% by weight of glycerin, and 13.8% by weight of water were added, and then the wet mixture was extrusion-molded in a molding process.

In this molding process, the following honeycomb molded bodies were manufactured: a raw honeycomb molded body which had approximately the same shape as the inner honeycomb fired body 110 illustrated in FIGS. 5A and 5B, and had the cells not sealed; and a raw honeycomb molded body which had approximately the same shape as the outer honeycomb fired body 120 illustrated in FIGS. 6A and 6B, and had the cells not sealed.

(2) Next, the raw honeycomb molded bodies were dried by using a microwave drying apparatus to have dried honeycomb molded bodies. Then, a filling process of filling a paste having the same composition as the above wet mixture into predetermined cells was performed, and after that, the honeycomb molded bodies were dried again by using a drying apparatus.

(3) The dried honeycomb molded bodies were degreased at 400° C., and then fired at 2200° C. under ordinary pressure argon atmosphere for three hours.

Thereby, an inner honeycomb fired body 110 was manufactured which was made of a porous silicon carbide sintered body having a porosity of 45%, an average pore diameter of 15 μm, a size of 34.5 mm×34.5 mm×150 mm, the number of cells (cell density) of 300 pcs/inch², a cell wall thickness of 0.25 mm (10 mil), and a cell width of 1.42 mm. Also, an outer honeycomb fired body 120 was manufactured which had the same porosity, average pore diameter, the number of cells (cell density), cell wall thickness, and cell width as the inner honeycomb fired body 110, and had a cross-sectional shape defined by three lines and one approximate circular arc with two angles of 90° and 135° each formed by two lines out of the three lines (line 120a=20.8 mm, line 120b=35.0 mm, line 120c=35.7 mm). Here, the deformed cell 124a is capable of receiving therein a circle of 0.90 mm in diameter in a cross section perpendicular to the longitudinal direction. Portions to be cells incapable of receiving therein a circle of 0.90 mm in diameter are filled in advance with a wet mixture so as to be a part of the peripheral wall of the honeycomb fired body, or are removed to leave cross-sectional recessed portions.

(4) An adhesive paste was applied to predetermined sides of the inner honeycomb fired bodies 110 and outer honeycomb fired bodies 120. By interposing the adhesive paste, four inner honeycomb fired bodies 110 and eight outer honeycomb fired bodies 120 were bonded in the arrangement illustrated in FIG. 4. Then, the adhesive paste was heated at 180° C. for 20 minutes to be solidified. As a result, a round pillar-shaped ceramic block 103 with 1-mm-thick adhesive layers was manufactured.

Here, an adhesive paste was used which contained 30.0% by weight of silicon carbide particles having an average particle diameter of 0.6 μm, 21.4% by weight of silica sol (solid content of 30% by weight), 8.0% by weight of carboxymethyl cellulose, and 40.6% by weight of water.

(5) By using the adhesive paste used in the above process (4), a coating material paste layer was formed around the periphery of the ceramic block 103. Thereafter, the coating material paste layer was dried at 120° C., so that a 143.8 mm (diameter)×150 mm (length) round pillar-shaped honeycomb structure 100 having a coat layer 102 formed on the periphery thereof was manufactured.

### Example 2

A honeycomb structure was manufactured by the same procedure as that in Example 1, except that in manufacture of the outer honeycomb fired bodies 120, honeycomb molded bodies for the outer honeycomb fired bodies 120 were manufactured with extrusion-molding dies having different shapes such that the deformed cells 124a were formed to be capable of receiving a circle of 0.95 mm in diameter in a cross section perpendicular to the longitudinal direction, and every cell incapable of receiving therein a circle of 0.95 mm in diameter was filled with a wet mixture so as to be a part of the peripheral wall of the honeycomb fired body or was removed to leave a cross-sectional recessed portion.

### Comparative Example 1

A honeycomb structure was manufactured by the same procedure as that in Example 1, except that in manufacture of the outer honeycomb fired bodies 120, honeycomb molded bodies for the outer honeycomb fired bodies 120 were manufactured with extrusion-molding dies having different shapes such that the deformed cells 124a were formed to be capable of receiving a circle of 0.85 mm in diameter in a cross section perpendicular to the longitudinal direction, and every cell incapable of receiving therein a circle of 0.85 mm in diameter was filled with a wet mixture so as to be a part of the peripheral wall of the honeycomb fired body or was removed to leave a cross-sectional recessed portion.

### Comparative Example 2

A honeycomb structure was manufactured by the same procedure as that in Example 1, except that in manufacture of the outer honeycomb fired bodies 120, honeycomb molded bodies for the outer honeycomb fired bodies 120 were manufactured with extrusion-molding dies having different shapes such that the deformed cells 124a were formed to be capable of receiving a circle of 0.80 mm in diameter in a cross section perpendicular to the longitudinal direction, and every cell incapable of receiving therein a circle of 0.80 mm in diameter was filled with a wet mixture so as to be a part of the peripheral wall of the honeycomb fired body or was removed to leave a cross-sectional recessed portion.

### (Evaluation of Sealing Defects)

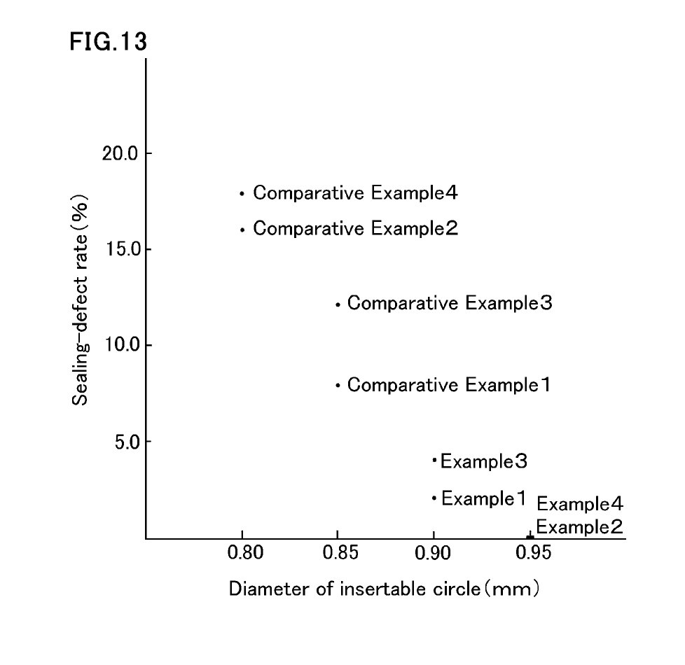

A light leakage test was conducted using 50 outer honeycomb fired body pieces manufactured in Examples and Comparative Examples. In the light leakage test, light is applied to the cell openings with a light leakage tester and whether the light leaks out of the sealed openings is checked. If even one of the cells in one outer honeycomb fired body leaked light, the outer honeycomb fired body was determined as defective and the sealing-defect rate thereof was calculated. Table 1 and FIG. 13 show the results.

TABLE 1

| | Shape of | Diameter of | The number | |
|---|---|---|---|---|
| | honeycomb | insertable | of sealing | Sealing-defect |
| | fired body | circle (mm) | defects | rate [%] |
| Example 1 | FIG. 6 | 0.90 | 1 | 2 |
| Example 2 | FIG. 6 | 0.95 | 0 | 0 |
| Comparative | FIG. 6 | 0.85 | 4 | 8 |
| Example 1 | | | | |
| Comparative | FIG. 6 | 0.80 | 8 | 16 |
| Example 2 | | | | |

As shown by the results in Table 1, the cell sealing-defect rate was 0% in Example 2 whereas the cell sealing-defect rate was 2% in Example 1, showing existence of a few defectively sealed cells. Still, the above sealing-defect rate was considered to be acceptable.

In contrast, in Comparative Examples 1 and 2, the respective cell sealing-defect rates greatly increased to 8% and 16%.

### Second Embodiment

Hereinafter, a second embodiment, which is another embodiment of the honeycomb structure of the present invention, will be described with reference to the drawings.

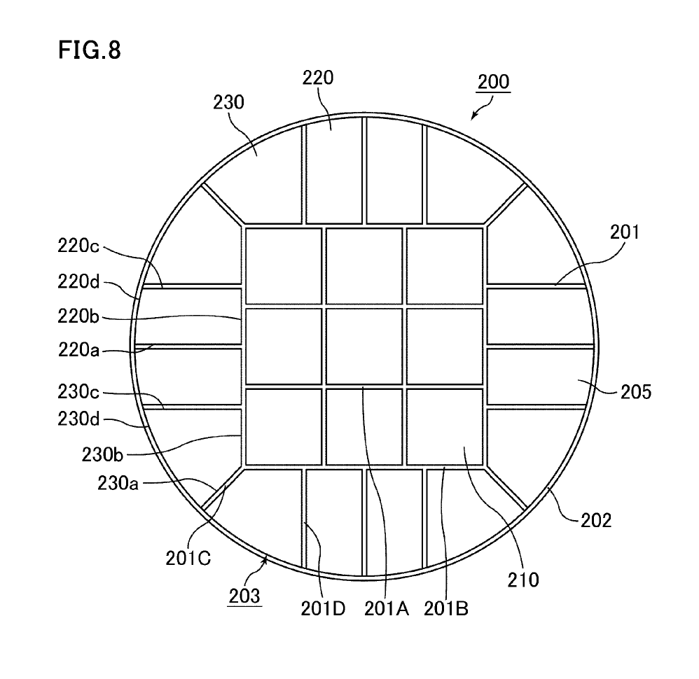

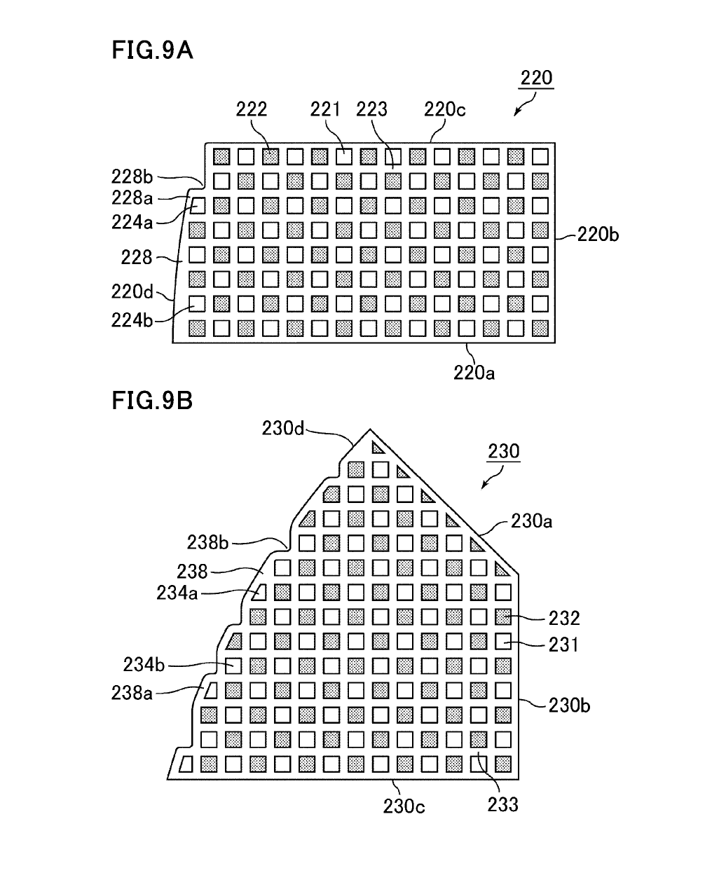

FIG. 8 is a cross-sectional view of a honeycomb structure according to a second embodiment of the present invention. FIG. 9A is a cross-sectional view schematically illustrating a portion near an end of an outer honeycomb fired body 220 constituting a honeycomb structure; and FIG. 9B is a cross-sectional view schematically illustrating a portion near an end of an outer honeycomb fired body 230 constituting the honeycomb structure.

A honeycomb structure 200 according to the present embodiment has, as illustrated in FIG. 8, a ceramic block 203 formed by bonding, by interposing adhesive layers 201A to 201D, eight outer honeycomb fired bodies 220, eight outer honeycomb fired bodies 230, and nine inner honeycomb fired bodies 210 located under the outer honeycomb fired bodies. The ceramic block 203 has a coat layer 202 formed around the periphery thereof.

Each inner honeycomb fired body 210 has an almost square cross-sectional shape.

Each outer honeycomb fired body 220 has a cross-sectional shape defined by three lines 220a, 220b, and 220c and one approximate circular arc 220d. Here, two angles each formed by two lines out of the three lines (the angle formed by the line 220a and the line 220b, and the angle formed by the line 220b and the line 220c) are both about 90°.

Each outer honeycomb fired body 230 in a cross section is an approximate sector having a cross-sectional shape defined by three lines 230a, 230b, and 230c and one approximate circular arc 230d. Here, two angles each formed by two lines out of the three lines (the angle formed by the line 230b and the line 230c, and the angle formed by the line 230a and the line 230b) are about 90° and about 135°, respectively.

Each of the honeycomb fired bodies 210, 220, and 230 is preferably formed by a porous silicon carbide sintered body or porous silicon-containing silicon carbide.

As illustrated in FIG. 9A, each of the eight outer honeycomb fired bodies 220 has a peripheral wall 228 constituting the periphery of the ceramic block 203, and the cells 221 and 224 (224a, 224b) of each outer honeycomb fired body 220 include peripheral cells 224a and 224b in contact with the peripheral wall 228 constituting the periphery of the ceramic block 203, and basic cells 221 located under the peripheral cells 224a and 224b. The peripheral cells 224a and 224b of the outer honeycomb fired body 220 include basic cells 224b each having the same shape as the basic cells 221 and deformed cells 224a each having a different shape from the basic cells 224b in a cross section perpendicular to the longitudinal direction. Each deformed cell 224a is capable of receiving therein a circle of about 0.90 mm in diameter in a cross section perpendicular to the longitudinal direction. Such a cell incapable of receiving therein a circle of about 0.90 mm in diameter is completely filled with the same material as the material of the cell walls so as to be a part of the peripheral wall 228 of the honeycomb fired body, or is removed to leave a cross-sectional recessed portion. Here, the symbol 222 refers to a plug.

Similarly to the outer honeycomb fired bodies 220, each of the eight outer honeycomb fired bodies 230 illustrated in FIG. 9B has a peripheral wall 238 constituting the periphery of the ceramic block 203, and the cells 231 and 234 (234a, 234b) of each outer honeycomb fired body 230 include peripheral cells 234a and 234b in contact with the peripheral wall 238 constituting the periphery of the ceramic block 203, and basic cells 231 located under the peripheral cells 234a and 234b. The peripheral cells 234a and 234b of the outer honeycomb fired body 230 include basic cells 234b each having the same shape as the basic cells 231 and deformed cells 234a each having a different shape from the basic cells 234b in a cross section perpendicular to the longitudinal direction. Each deformed cell 234a is capable of receiving therein a circle of about 0.90 mm in diameter in a cross section perpendicular to the longitudinal direction. Such a cell incapable of receiving therein a circle of about 0.90 mm in diameter is completely filled with the same material as the material of the cell walls so as to be a part of the peripheral wall 238 of the honeycomb fired body, or is removed to leave a cross-sectional recessed portion. Here, the symbol 232 refers to a plug.

The peripheral walls 228 and 238 have an irregularity due to respective projected portions 228a and 238a and respective recessed portions 228b and 238b in a cross section perpendicular to the longitudinal direction, and the projected portions 228a and 238a and the recessed portions 228b and 238b each have a cross-sectional shape defined by a curved line formed by R-chamfering. The curvature radius for the R-chamfering is from about 0.3 mm to about 2.5 mm.

Also in this honeycomb structure 200, the cells are sealed at alternate ends to function as filters for capturing PMs.

Next, the method of manufacturing the honeycomb structure according to the present embodiment is described.

The method of manufacturing a honeycomb structure in the present embodiment is substantially the same as the method of manufacturing a honeycomb structure in the first embodiment of the present invention, except for the following points.

Firstly, each honeycomb molded body manufactured in the molding process (1) in the manufacturing method according to the first embodiment of the present invention has approximately the same shape as the inner honeycomb fired body 210 or the outer honeycomb fired body 220 or 230 illustrated in FIG. 8 except that the cells are not sealed at alternate ends. Secondly, the honeycomb fired bodies are bonded in the bonding process (4) in the manufacturing method according to the first embodiment of the present invention such that the inner honeycomb fired bodies 210 and the outer honeycomb fired bodies 220 and 230 are located at the positions illustrated in FIG. 8.

The honeycomb structure according to the present embodiment can provide the same effects as the honeycomb structure according to the first embodiment of the present invention.

Hereinafter, Examples are shown which more specifically disclose the second embodiment of the present invention. The present invention is not limited to those Examples.

### Example 3

(1) By the same method as the molding process (1) in Example 1, raw honeycomb molded bodies were manufactured which had approximately the same shape as the inner honeycomb fired bodies 210 illustrated in FIG. 8 or the outer honeycomb fired bodies 220 or 230 and had the cells not sealed.

(2) Next, the raw honeycomb molded bodies were dried using a microwave drying apparatus to provide dried bodies of the honeycomb molded bodies. Then, a paste having the same composition as the above wet mixture was filled into predetermined cells and the dried bodies were dried again using a drying apparatus.

(3) The dried honeycomb molded bodies were degreased at 400° C., and then fired at 2200° C. under ordinary pressure argon atmosphere for three hours.

Thereby, the following honeycomb fired bodies were manufactured: inner honeycomb fired bodies 210 each made of a porous silicon carbide sintered body having a porosity of 45%, an average pore diameter of 15 μm, a size of 34.5 mm×34.5 mm×200 mm, the number of cells (cell density) of 300 pcs/inch², a cell wall thickness of 0.25 mm (10 mil), and a cell width of 1.42 mm; outer honeycomb fired bodies 220 each having the same porosity, average pore diameter, the number of cells (cell density), cell wall thickness, and cell width as the inner honeycomb fired bodies 210, and a cross-sectional shape defined by three lines and one approximate circular arc with two angles of 90° each formed by two lines out of the three lines (line 220a=45.6 mm, line 220b=26.8 mm, line 220c=41.8 mm) ; and outer honeycomb fired bodies 230 each having the same porosity, average pore diameter, the number of cells (cell density), cell wall thickness, and cell width as the inner honeycomb fired bodies 210, and a cross-sectional shape defined by three lines and one approximate circular arc with two angles of 90° and 135° each formed by two lines out of the three lines (line 230a=24.9 mm, line 230b=24.5 mm, line 230c=41.8 mm). Here, the deformed cells 224a and 234a each were capable of receiving therein a circle of 0.90 mm in diameter in a cross section perpendicular to the longitudinal direction. Portions to be cells incapable of receiving therein a circle of 0.90 mm in diameter were filled with the same material as the material of the cell walls so as to be a part of the peripheral wall of the honeycomb fired body, or were removed to leave cross-sectional recessed portions.

(4) An adhesive paste was applied to predetermined sides of the inner honeycomb fired bodies 210 and the outer honeycomb fired bodies 220 and 230. By interposing the adhesive paste, nine inner honeycomb fired bodies 210, eight outer honeycomb fired bodies 220, and eight outer honeycomb fired bodies 230 were bonded in the arrangement illustrated in FIG. 8. Then, the adhesive paste was heated at 180° C. for 20 minutes to be solidified. As a result, a round pillar-shaped ceramic block 203 with 1-mm-thick adhesive layers was manufactured.

The adhesive paste used here was the same as the adhesive paste in Example 1.

(5) By using the adhesive paste used in the above process (4), a coating material paste layer was formed around the periphery of the ceramic block 203. Thereafter, the coating material paste layer was dried at 120° C., so that a 203.2 mm (diameter)×200 mm (length) round pillar-shaped honeycomb structure 200 having a coat layer 202 formed on the periphery thereof was manufactured.

### Example 4

A honeycomb structure was manufactured by the same procedure as that in Example 3, except that in manufacture of the outer honeycomb fired bodies 220 and 230, honeycomb molded bodies for the outer honeycomb fired bodies 220 and 230 were manufactured with extrusion-molding dies having different shapes such that the deformed cells 224a and 234a were formed to be capable of receiving a circle of 0.95 mm in diameter in a cross section perpendicular to the longitudinal direction, and every cell incapable of receiving therein a circle of 0.95 mm in diameter was filled with a wet mixture so as to be a part of the peripheral wall of the honeycomb fired body or was removed to leave a cross-sectional recessed portion.

### Comparative Example 3

A honeycomb structure was manufactured by the same procedure as that in Example 3, except that in manufacture of the outer honeycomb fired bodies 220 and 230, honeycomb molded bodies for the outer honeycomb fired bodies 220 and 230 were manufactured with extrusion-molding dies having different shapes such that the deformed cells 224a and 234a were formed to be capable of receiving a circle of 0.85 mm in diameter in a cross section perpendicular to the longitudinal direction, and every cell incapable of receiving therein a circle of 0.85 mm in diameter was filled with a wet mixture so as to be a part of the peripheral wall of the honeycomb fired body or was removed to leave a cross-sectional recessed portion.

### Comparative Example 4

A honeycomb structure was manufactured by the same procedure as that in Example 3, except that in manufacture of the outer honeycomb fired bodies 220 and 230, honeycomb molded bodies for the outer honeycomb fired bodies 220 and 230 were manufactured with extrusion-molding dies having different shapes such that the deformed cells 224a and 234a were formed to be capable of receiving a circle of 0.80 mm in diameter in a cross section perpendicular to the longitudinal direction, and every cell incapable of receiving therein a circle of 0.80 mm in diameter was filled with a wet mixture so as to be a part of the peripheral wall of the honeycomb fired body or was removed to leave a cross-sectional recessed portion.

### (Evaluation of Sealing Defects)

The honeycomb structures in Examples 3 and 4 and Comparative Examples 3 and 4 were checked for sealing defects in the same manner as that for the outer honeycomb fired bodies manufactured in Examples 1 and 2 and Comparative Examples 1 and 2, and the sealing-defect rates were calculated. The results are shown in Table 2 and FIG. 13.

TABLE 2

| | Shape of | Diameter of | The number | |
|---|---|---|---|---|
| | honeycomb | insertable | of sealing | Sealing-defect |
| | fired body | circle (mm) | defects | rate [%] |
| Example 3 | FIG. 9 | 0.90 | 2 | 4 |
| Example 4 | FIG. 9 | 0.95 | 0 | 0 |
| Comparative | FIG. 9 | 0.85 | 6 | 12 |
| Example 3 | | | | |
| Comparative | FIG. 9 | 0.80 | 9 | 18 |
| Example 4 | | | | |

As shown by the results in Table 2, the cell sealing-defect rate was 0% in Example 4 whereas the cell sealing-defect rate was 4% in Example 3, showing existence of a few defectively sealed cells. Still, the above sealing-defect rate was considered to be acceptable.

In contrast, in Comparative Examples 3 and 4, the respective cell sealing-defect rates greatly increased to 12% and 18%.

FIG. 13 is a graph showing the diameters of the insertable circles and the sealing-defect rates in Examples 1 to 4 and Comparative Examples 1 to 4.

In Examples 1 to 4 in which each deformed cell was capable of receiving therein a circle of 0.90 mm or 0.95 mm in diameter in a cross section perpendicular to the longitudinal direction as illustrated in FIG. 13, the sealing-defect rate was very low and was of a level that would not cause a problem.

In contrast, in Comparative Examples 1 to 4 in which each deformed cell was capable of receiving therein a circle of 0.85 mm or 0.80 mm in diameter in a cross section perpendicular to the longitudinal direction, the sealing-defect rate was apparently not sufficiently low and decreased the manufacturing efficiency.

### Third Embodiment

FIG. 10A is a cross-sectional view schematically illustrating a portion near an end of an outer honeycomb fired body constituting a honeycomb structure according to a third embodiment of the present invention. FIG. 10B is a cross-sectional view schematically illustrating a portion near an end of an inner honeycomb fired body constituting the honeycomb structure according to the third embodiment of the present invention.

The honeycomb structure according to the third embodiment of the present invention is produced from honeycomb fired bodies 310 and honeycomb fired bodies 320 respectively having the same external shapes as those illustrated in FIGS. 5 and 6, except that the basic cells and the peripheral cells excluding the deformed cells include large-volume cells and small-volume cells, and each large-volume cell has a larger area than the small-volume cells in a cross section perpendicular to the longitudinal direction. Also, the arrangement of the honeycomb fired bodies 310 and 320 constituting a honeycomb structure is the same as that of the honeycomb structure illustrated in FIG. 4.

More specifically, each inner honeycomb fired body 310 has an almost square cross-sectional shape and each outer honeycomb fired body 320 has a cross-sectional shape defined by three lines 320a, 320b, and 320c and one approximate circular arc 320d. Here, two angles each formed by two lines out of the three lines (the angle formed by the line 320b and the line 320c, and the angle formed by the line 320a and the line 320b) are about 90° and about 135°, respectively.

As illustrated in FIGS. 10A and 10B, each outer honeycomb fired body 320 has a peripheral wall 328 constituting the periphery of the ceramic block, and cells 321 (321a, 321b) and 324 (324a, 324b, 324c) in each outer honeycomb fired body 320 include peripheral cells 324a, 324b, and 324c in contact with the peripheral wall 328 constituting the periphery of the ceramic block, and basic cells 321a and 321b located under the peripheral cells 324a, 324b, and 324c. The basic cells 321 include large-volume cells 321a each having a larger area than small-volume cells 321b in a cross section perpendicular to the longitudinal direction, and the small-volume cells 321b each having a smaller cross-sectional area than the large-volume cells 321a.

The peripheral cells 324a, 324b, and 324c of each outer honeycomb fired body 320 include basic cells 324a and 324b each having the same shape as the basic cells 321a and 321b and deformed cells 324c each having a different shape from the basic cells 324a and 324b in a cross section perpendicular to the longitudinal direction. Each deformed cell 324c is capable of receiving therein a circle of about 0.90 mm in diameter in a cross section perpendicular to the longitudinal direction. Such a cell incapable of receiving therein a circle of about 0.90 mm in diameter is completely filled with the same material as the material of the cell walls so as to be a part of the peripheral wall 328 of the honeycomb fired body, or is removed to leave a cross-sectional recessed portion.

The inner honeycomb fired bodies 310 are located under those outer honeycomb fired bodies 320 and include large-volume cells 310a and small-volume cells 310b. Here, the symbol 322 refers to a plug.

Each peripheral wall 328 has an irregularity due to a projected portion 328a and a recessed portion 328b in a cross section perpendicular to the longitudinal direction, and the projected portion 328a and the recessed portion 328b each have a cross-sectional shape defined by a curved line formed by R-chamfering. The curvature radius for the R-chamfering is from about 0.3 mm to about 2.5 mm.

Also in this honeycomb structure according to the third embodiment of the present invention, the cells are sealed at alternate ends to function as filters for capturing PMs.

The honeycomb structure according to the third embodiment of the present invention provides the same effects as the first embodiment of the present invention, and can capture a larger amount of PMs than the honeycomb structure 100 in which every cell has the same cross-sectional area.

Each of the honeycomb fired bodies 310 and 320 constituting the above honeycomb structure is preferably a porous body made of silicon carbide or silicon-containing silicon carbide.

### Fourth Embodiment

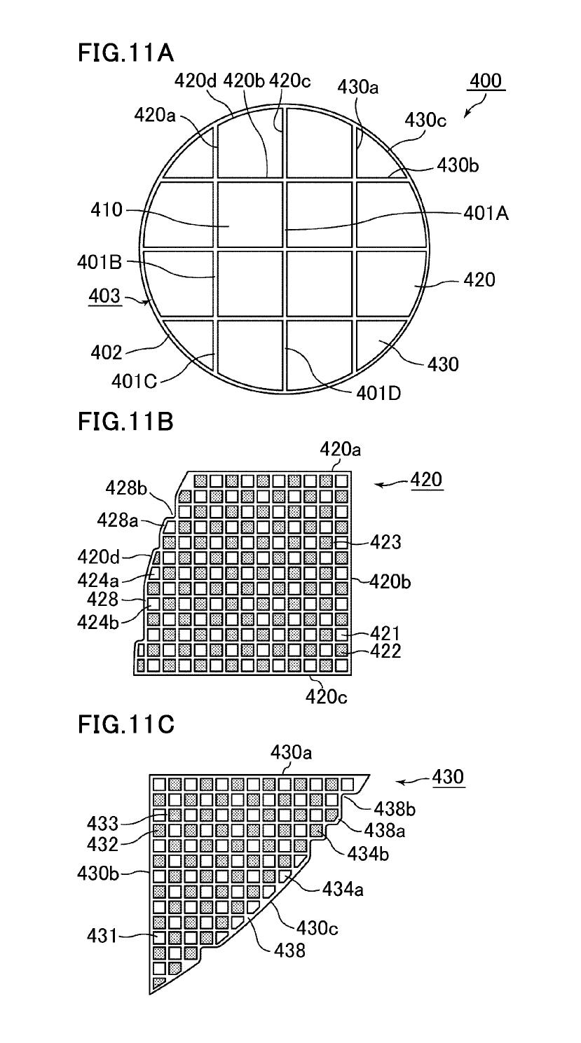

FIGS. 11A, 11B, and 11C are perspective views each schematically illustrating a honeycomb structure according to a fourth embodiment of the present invention. FIG. 11A is a cross-sectional view schematically illustrating a portion near an end of a honeycomb structure 400 according to the fourth embodiment of the present invention; FIG. 11B is a cross-sectional view schematically illustrating a portion near an end of an outer honeycomb fired body 420 constituting the honeycomb structure illustrated in FIG. 11A; and FIG. 11C is a cross-sectional view schematically illustrating a portion near an end of an outer honeycomb fired body 430 constituting the honeycomb structure illustrated in FIG. 11A.

The honeycomb structure 400 illustrated in FIGS. 11A, 11B, and 11C has a ceramic block 403 formed by bonding, by interposing adhesive layers 401 (401A to 401D), eight outer honeycomb fired bodies 420 each having a shape illustrated in FIG. 11B, four outer honeycomb fired bodies 430 each having a shape illustrated in FIG. 11C, and four inner honeycomb fired bodies 410 located under the outer honeycomb fired bodies. The ceramic block 403 has a coat layer 402 formed on the periphery thereof.

Each inner honeycomb fired body 410 has an almost square cross-sectional shape.

Each outer honeycomb fired body 420 has a cross-sectional shape defined by three lines 420a, 420b, and 420c and one approximate circular arc 420d, as illustrated in FIG. 11B. The angles formed by the line 420a and the line 420b and by the line 420b and the line 420c were both about 90°. As illustrated in FIG. 11C, the outer honeycomb fired body 430 has a cross-sectional shape defined by two lines 430a and 430b and one approximate circular arc 430c, and the line 430a and the line 430b form an angle of about 90°.

As illustrated in FIG. 11B, each outer honeycomb fired body 420 has a peripheral wall 428 constituting the periphery of the ceramic block 403, and the cells 421 and 424 (424a, 424b) of each outer honeycomb fired body 420 include peripheral cells 424a and 424b in contact with the peripheral wall 428 constituting the periphery of the ceramic block 403, and basic cells 421 located under the peripheral cells 424a and 424b. The peripheral cells 424a and 424b of the outer honeycomb fired body 420 include basic cells 424b each having the same shape as the basic cells 421 and deformed cells 424a each having a different shape from the basic cells 424b in a cross section perpendicular to the longitudinal direction. Each deformed cell 424a is capable of receiving therein a circle of about 0.90 mm in diameter in a cross section perpendicular to the longitudinal direction. Such a cell incapable of receiving therein a circle of about 0.90 mm in diameter is completely filled with the same material as the material of the cell walls so as to be the peripheral wall 428 of the honeycomb fired body, or is removed to leave a cross-sectional recessed portion.

As illustrated in FIG. 11C, the outer honeycomb fired body 430 has a peripheral wall 438 constituting the periphery of the ceramic block 403, and the cells 431 and 434 (434a, 434b) of each outer honeycomb fired body 430 include peripheral cells 434a and 434b in contact with the peripheral wall 438 constituting the periphery of the ceramic block 403, and basic cells 431 located under the peripheral cells 434a and 434b. The peripheral cells 434a and 434b of the outer honeycomb fired body 430 include basic cells 434b each having the same shape as the basic cells 431 and deformed cells 434a each having a different shape from the basic cells 434b in a cross section perpendicular to the longitudinal direction. Each deformed cell 434a is capable of receiving therein a circle of about 0.90 mm in diameter in a cross section perpendicular to the longitudinal direction. Such a cell incapable of receiving therein a circle of about 0.90 mm in diameter is completely filled with the same material as the material of the cell walls so as to be a part of the peripheral wall 438 of the honeycomb fired body, or is removed to leave a cross-sectional recessed portion.

The peripheral walls 428 and 438 of the honeycomb fired body have an irregularity due to respective projected portions 428a and 438a and respective recessed portions 428b and 438b in a cross section perpendicular to the longitudinal direction, and the projected portions 428a and 438a and the recessed portions 428b and 438b each have a cross-sectional shape defined by a curved line formed by R-chamfering. The curvature radius for the R-chamfering is from about 0.3 mm to about 2.5 mm.

Also in this honeycomb structure 400, the cells are sealed at alternate ends to function as filters for capturing PMs.

Each of the honeycomb fired bodies 410, 420, and 430 constituting the above honeycomb structure 400 is preferably a porous body made of silicon carbide or silicon-containing silicon carbide.

### Other Embodiments

The cross-sectional shape of the honeycomb structure according to the embodiment of the present invention is not limited to an approximate circle, and may be, for example, an approximate ellipse, an approximate flat oval, an approximate racetrack shape, or the like.

Although the ceramic block has a coat layer formed on the periphery thereof in the above embodiments of the present invention, the ceramic block may not have a coat layer.

The honeycomb structure according to the embodiment of the present invention is not required to always have a plurality of inner honeycomb fired bodies, and may have only one inner honeycomb fired body.

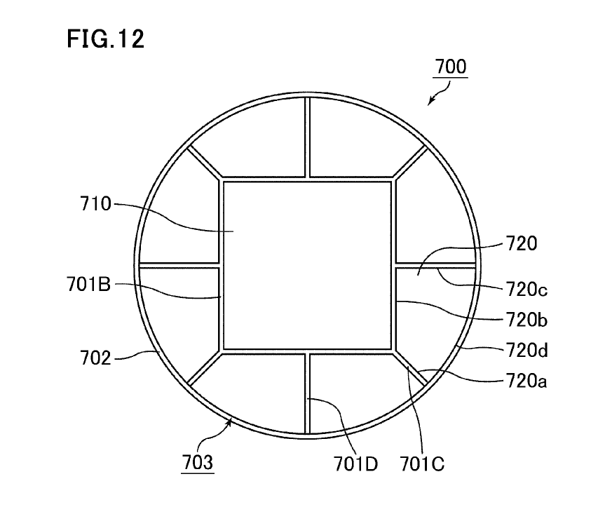

FIG. 12 is a cross-sectional view of a honeycomb structure according to another embodiment of the present invention.

A honeycomb structure 700 illustrated in FIG. 12 has the same structure as the honeycomb structure 100 according to the first embodiment of the present invention, except having only one inner honeycomb fired body.

More specifically, the honeycomb structure 700 illustrated in FIG. 12 has one inner honeycomb fired body 710 in place of the four inner honeycomb fired bodies 110 bonded by interposing the adhesive layers 101A in the honeycomb structure 100 illustrated in FIG. 4.

The inner honeycomb fired body 710 has a larger cross-sectional area than the inner honeycomb fired bodies 100, but the functions thereof are substantially the same. Outer honeycomb fired bodies 720 are the same as the honeycomb fired bodies 120 constituting the honeycomb structure 100.

The peripheral wall of each honeycomb fired body has an irregularity due to a projected portion and a recessed portion in a cross-sectional perpendicular to the longitudinal direction, and the projected portion and the recessed portion each preferably have a cross-sectional shape formed by chamfering. The type of chamfering is not particularly limited and may be C-chamfering or R-chamfering. Still, R-chamfering is preferable and the curvature radius is preferably from about 0.3 mm to about 2.5 mm.

Although the thickness of the peripheral wall constituting the periphery of the ceramic block is not particularly limited, the thickness is preferably larger than the thickness of the cells walls located on the inner side of the honeycomb fired body (ceramic block), and is more preferably from about 1.3 times to about 3.0 times the thickness of the cell walls located on the inner side of the honeycomb fired body (ceramic block).

In the honeycomb structures according to the embodiments of the present invention, each inner honeycomb fired body preferably has an area of from about 900 mm² to about 2500 mm² in a cross section perpendicular to the longitudinal direction.

This is because a cross-sectional area of an inner honeycomb fired body within the above range is not likely to cause cracks in the honeycomb fired body when the honeycomb fired body expands or contracts in a regeneration process for the honeycomb structure.

In the honeycomb structures according to the embodiments of the present invention, the basic cells and the peripheral cells excluding the deformed cells may include large-volume cells and small-volume cells as illustrated in FIG. 10. In this case, each large-volume cell and each small-volume cell may have any cross-sectional shape. That is, each large-volume cell may have an almost octagonal cross-sectional shape and each small-volume cell may have an almost quadrangular cross-sectional shape as illustrated in FIG. 10. Alternatively, each large-volume cell and each small-volume cell may have an almost quadrangular shape in a cross section perpendicular to the longitudinal direction. Yet alternatively, each cell may have a cross-sectional shape defined by a curved line.

In the honeycomb structures according to the embodiments of the present invention, the area ratio of the small-volume cells to the large-volume cells in a cross section perpendicular to the longitudinal direction (cross-sectional area of large-volume cells/cross-sectional area of small-volume cells) is preferably from about 1.01 to about 9.00.

In the honeycomb structures according to the embodiments of the present invention, the cells may not be sealed at the ends. Such a honeycomb structure can be used as a catalyst supporting body.

The ceramic block according to each embodiment of the present invention may include honeycomb fired bodies of cake shapes. The number of the cake shapes for the honeycomb fired bodies is not particularly limited, and may be only one or may be two or more.

The cake shape here means the shape of one of a plurality of pillar pieces resulting from cutting a pillar through the center. Combining a plurality of cake shaped honeycomb fired bodies gives a round-pillar shape.

A ceramic block may be formed from one honeycomb fired body.

In the case that a ceramic block is formed from one honeycomb fired body, the honeycomb fired body is preferably made of cordierite or aluminum titanate. Even when a ceramic block is formed from one honeycomb fired body, the same effects are expected to be provided.

Examples of the inorganic binder in the adhesive paste and the coating material paste include silica sol, alumina sol binders, and the like. Each of these may be used alone or two or more kinds of these may be used in combination. Silica sol binder is preferable among the inorganic binders.

Examples of inorganic particles in the above adhesive paste and coating material paste include inorganic particles produced from carbide, nitride, or the like, and more specifically include inorganic particles produced from silicon carbide, silicon nitride, boron nitride, or the like. Each of these maybe used alone or two or more kinds of these may be used in combination. Among the inorganic particles, inorganic particles produced from silicon carbide are preferable because they have excellent thermal conductivity.

Examples of inorganic fibers and/or whisker in the adhesive paste and the coating material paste include inorganic fibers and/or whisker produced from silica alumina, mullite, alumina, silica, or the like. Each of these may be used alone or two or more kinds of these may be used in combination. Alumina fibers are preferable among the inorganic fibers.

The average pore diameter of the honeycomb fired bodies is preferably from about 5 μm to about 30 μm. In the case that a honeycomb structure formed from honeycomb fired body(ies) is used as a honeycomb filter, an average pore diameter of each honeycomb fired body of about 5 μm or more may easily cause particulate clogging whereas, in contrast, an average pore diameter of about 30 μm or less may allow particulates to easily pass through the pores. As a result, the honeycomb structure may not be able to sufficiently serve as a filter.

Here, the porosity and the pore diameter can be measured by a conventionally known method of mercury porosimetry.

The cell density of each honeycomb fired body in a cross section is not particularly limited, and is preferably about 31.0 pcs/cm² (about 200 pcs/in²) at the minimum, is preferably about 93 pcs/cm² (about 600 pcs/in²) at the maximum, is more preferably about 38.8 pcs/cm² (about 250 pcs/in²) at the minimum, and is more preferably about 77.5 pcs/cm² (about 500 pcs/in²) at the maximum.

The thickness of the cell wall of each honeycomb fired body is not particularly limited, and is preferably from about 0.1 mm to about 0.4 mm.

The main component of the honeycomb fired body is not limited to silicon carbide, and may be powders of the following ceramics: nitride ceramics such as aluminum nitride, silicon nitride, boron nitride, and titanium nitride; carbide ceramics such as zirconium carbide, titanium carbide, tantalum carbide, and tungsten carbide; oxide ceramics such as cordierite and aluminum titanate; and the like. Among these, the main component of a honeycomb fired body, in the case of a honeycomb structure formed from a plurality of honeycomb fired bodies, is preferably non-oxide ceramics, and is particularly preferably silicon carbide or silicon-containing silicon carbide because they are excellent in heat resistance, mechanical strength, thermal conductivity, and the like.

The organic binder to be mixed into the wet mixture is not particularly limited, and examples of compounds used as the organic binder include methylcellulose, carboxy methylcellulose, hydroxy ethylcellulose, polyethylene glycol, and the like. Methylcellulose is preferable among these. The blending amount of the organic binder is preferably from about 1 part by weight to about 10 parts by weight per 100 parts by weight of the ceramic powder.

The plasticizer to be mixed into the wet mixture is not particularly limited, and examples of compounds used as the plasticizer include glycerin.

The lubricant to be mixed into the wet mixture is not particularly limited, and examples of compounds used as the lubricant include polyoxyalkylene-based compounds such as polyoxyethylene alkyl ether and polyoxypropylene alkyl ether; polyoxyethylene monobutyl ether; polyoxypropylene monobutyl ether; and the like.

The plasticizer and the lubricant may not be contained in the wet mixture in some cases.

In addition, a dispersant solution may be used in preparation of the above wet mixture, and examples of the dispersant solution include water, an organic solvent such as benzene, alcohol such as methanol, and the like.

Furthermore, a molding aid may be added to the wet mixture.

The molding aid is not particularly limited, and examples of compounds used as the molding aid include ethylene glycol, dextrin, fatty acid, fatty acid soap, polyalcohol, and the like.

Furthermore, a pore-forming agent such as balloons that are fine hollow spheres including oxide-based ceramics, spherical acrylic particles, and graphite may be added to the wet mixture according to need.

The balloon is not particularly limited, and examples thereof include alumina balloon, glass micro balloon, shirasu balloon, fly ash balloon (FA balloon), mullite balloon, and the like. Alumina balloon is preferable among these.

Each of the above honeycomb structures may have supported therein a catalyst for purifying exhaust gases, and preferable examples of the catalyst include noble metals such as platinum, palladium, and rhodium. Among these, platinum is more preferable. Other examples of the catalyst include alkali metals such as potassium and sodium, and alkaline earth metals such as barium. Each of these catalysts may be used alone or two or more kinds of these may be used in combination.

The bonding process in the method of producing a honeycomb structure according to each embodiment of the present invention is performed by a method of applying an adhesive paste to a side of each honeycomb fired body. Alternatively, the bonding process may be performed by another method such as a method of provisionally fixing honeycomb fired bodies in a mold of approximately the same shape as a ceramic block to be manufactured (or an aggregate of honeycomb fired bodies), and then injecting an adhesive paste between the honeycomb fired bodies.

Obviously, numerous modifications and variations of the present invention are possible in light of the above teachings. It is therefore to be understood that within the scope of the appended claims, the invention may be practiced otherwise than as specifically described herein.

1. A honeycomb structure comprising:
a ceramic block including at least one honeycomb fired body that has a first peripheral wall constituting a periphery of the at least one honeycomb fired body and that has cell walls extending along a longitudinal direction of the at least one honeycomb fired body to define cells comprising:
peripheral cells in contact with the first peripheral wall of the at least one honeycomb fired body constituting a periphery of the ceramic block;
basic cells arranged at an inner side of the peripheral cells; and
the peripheral cells including deformed cells each having a different shape from the basic cells in a cross section perpendicular to the longitudinal direction of the at least one honeycomb fired body, each of the deformed cells being capable of receiving therein a circle of about 0.9 mm in diameter in the cross section perpendicular to the longitudinal direction.

2. The honeycomb structure according to claim 1,
wherein
each of the deformed cells is capable of receiving therein a circle of about 0.95 mm in diameter, in the cross section perpendicular to the longitudinal direction.

3. The honeycomb structure according to claim 1,
wherein
the cells further comprise
a deformed small cell incapable of receiving therein
a circle of about 0.9 mm in diameter, and
the first peripheral wall constituting the periphery of the ceramic block comprises
a second peripheral wall formed by completely filling the deformed small cell with a same material as a material of the cell walls.

4. The honeycomb structure according to claim 1,
wherein
the ceramic block is formed by bonding a plurality of honeycomb fired bodies by interposing adhesive layers.

5. The honeycomb structure according to claim 4,
wherein
the ceramic block is formed by combining the plurality of honeycomb fired bodies having different shapes from each other, and comprises
outer honeycomb fired bodies each having a third peripheral wall constituting the periphery of the ceramic block, and
one or more inner honeycomb fired bodies arranged at an inner side of the outer honeycomb fired bodies.

6. The honeycomb structure according to claim 1,
wherein
the first peripheral wall of the at least one honeycomb fired body constituting the periphery of the ceramic block has an irregularity comprising a projected portion and a recessed portion, in the cross section perpendicular to the longitudinal direction, and
wherein
the projected portion has a shape defined by a curved line formed by chamfering the projected portion, and/or
the recessed portion has a shape defined by a curved line formed by chamfering the recessed portion.

7. The honeycomb structure according to claim 6,
wherein
the projected portion has a shape formed by R-chamfering the projected portion,
the recessed portion has a shape formed by R-chamfering the recessed portion, and
a curvature radius for the R-chamfering is from about 0.3 mm to about 2.5 mm.

8. The honeycomb structure according to claim 1,
wherein
each of the basic cells and each of the peripheral cells excluding the deformed cells have an almost quadrangular shape in the cross section perpendicular to the longitudinal direction.

9. The honeycomb structure according to claim 1,
wherein
the basic cells and the peripheral cells excluding the deformed cells comprise large-volume cells and small-volume cells, and
each of the large-volume cells has an area larger than the small-volume cells in the cross section perpendicular to the longitudinal direction.

10. The honeycomb structure according to claim 9,
wherein
each of the large-volume cells and each of the small-volume cells have an almost quadrangular shape, in the cross section perpendicular to the longitudinal direction.

11. The honeycomb structure according to claim 9,
wherein
each of the large-volume cells has an almost octagonal shape and each of the small-volume cells has an almost quadrangular shape, in the cross section perpendicular to the longitudinal direction.

12. The honeycomb structure according to claim 9,
wherein
each of the large-volume cells and each of the small-volume cells have a shape defined by a curved line, in the cross section perpendicular to the longitudinal direction.

13. The honeycomb structure according to claim 1,
wherein
the first peripheral wall of the at least one honeycomb fired body constituting the periphery of the ceramic block has a thickness larger than a cell wall among the cell walls, located on an inner side of the at least one honeycomb fired body.

14. The honeycomb structure according to claim 13,
wherein
the first peripheral wall of the at least one honeycomb fired body constituting the periphery of the ceramic block has the thickness of from about 1.3 times to about 3 times a thickness of the cell wall located on the inner side of the at least one honeycomb fired body.

15. The honeycomb structure according to claim 5,
wherein
each of the outer honeycomb fired bodies is an approximate sector having a shape defined by three straight lines and a fourth peripheral wall constituting apart of the periphery of the ceramic block in the cross section perpendicular to the longitudinal direction, and
each of the inner honeycomb fired bodies has an almost quadrangular shape in the cross section perpendicular to the longitudinal direction.

16. The honeycomb structure according to claim 1,
wherein
the at least one honeycomb fired body has a first end portion and a second end portion opposite to the first end portion in the longitudinal direction, and
the cells are alternately sealed at the first end portion and the second end portion.

17. The honeycomb structure according to claim 1,
wherein
the ceramic block has a coat layer provided on the periphery thereof.

18. The honeycomb structure according to claim 5,
wherein
the ceramic block has eight outer honeycomb fired bodies and four inner honeycomb fired bodies.

19. The honeycomb structure according to claim 15,
wherein
two angles each formed by two lines out of the three lines are about 90° and about 135°, respectively.

20. The honeycomb structure according to claim 1, wherein
in a peripheral portion in a cross section of the honeycomb structure, an adhesive layer provided from a corner of a central portion toward the periphery of the honeycomb structure and an adhesive layer provided from a portion of the central portion, other than the corner of the central portion, toward the periphery of the honeycomb structure form an angle of about 45°.

21. The honeycomb structure according to claim 1,
wherein
a cell incapable of receiving therein a circle of about 0.9 mm in diameter among the cells is removed to leave a recessed portion in a cross section of the ceramic block perpendicular to a longitudinal direction of the cells.

22. The honeycomb structure according to claim 1,
wherein
the at least one honeycomb fired body comprises silicon carbide or silicon-containing silicon carbide.

23. The honeycomb structure according to claim 5,
wherein
the ceramic block has 16 outer honeycomb fired bodies and 9 inner honeycomb fired bodies.

24. The honeycomb structure according to claim 5,
wherein
the outer honeycomb fired bodies include
first honeycomb fired bodies each having a shape defined by three straight lines and one approximate circular arc in the cross section perpendicular to the longitudinal direction, and
second honeycomb fired bodies each having a shape defined by two straight lines and one approximate circular arc in the cross section perpendicular to the longitudinal direction.

25. The honeycomb structure according to claim 5,
wherein
a number of the inner honeycomb fired bodies is one.

26. The honeycomb structure according to claim 5,
wherein
each of the inner honeycomb fired bodies has an area of from about 900 mm² to about 2500 mm² in the cross section perpendicular to the longitudinal direction.

27. The honeycomb structure according to claim 9,
wherein
an area ratio of the small-volume cells to the large-volume cells in the cross section perpendicular to the longitudinal direction is from about 1.01 to about 9.

28. The honeycomb structure according to claim 1,
wherein
the ceramic block includes the at least one honeycomb fired body having a cake shape being a shape of one of a plurality of pillar pieces resulting from cutting a pillar through a center.

29. The honeycomb structure according to claim 1,
wherein
the ceramic block is one honeycomb fired body as the at least one honeycomb fired body.

30. The honeycomb structure according to claim 29,
wherein
the one honeycomb fired body comprises cordierite or aluminum titanate.

31. The honeycomb structure according to claim 1,
wherein
the honeycomb structure has supported therein a catalyst.
